(19) United States
(12) Patent Application Publication
(10) Pub. No.: US 2026/0025721 A1
(43) Pub. Date: Jan. 22, 2026

(54) L1/L2 Inter-Cell Mobility Execution

(71) Applicant: Telefonaktiebolaget LM Ericsson (publ), Stockholm (SE)

(72) Inventors: Icaro Leonardo Da Silva, Solna (SE); Antonino Orsino, Kirkkonummi (FI); Pontus Wallentin, Linköping (SE); Stefan Wager, Espoo (FI)

(21) Appl. No.: 18/995,993

(22) PCT Filed: Jun. 22, 2023
(86) PCT No.: PCT/SE2023/050653

§ 371 Date: Jan. 17, 2025

Related U.S. Application Data
(60) Provisional application No. 63/395,907, filed on Aug. 8, 2022.

(51) Int. Cl. H04W 36/04; H04B 7/06; H04W 36/08; H04W 74/0833; H04W 76/20

(52) U.S. Cl. CPC H04W 36/04; H04B 7/06968; H04W 36/085; H04W 74/0833; H04W 76/20

(57) ABSTRACT

Embodiments include methods for a user equipment (UE) configured to communicate with a radio access network (RAN) node comprising a central unit (CU) and a distributed unit (DU) that provides a serving cell for the UE. Such methods include receiving from the DU a lower layer signalling message indicating that the UE should perform L1/L2-based inter-cell mobility to a first candidate cell provided by a candidate DU. The lower layer signaling message includes an indicator or identity of the first candidate cell, and an indication of a first TCI state to be used by the UE for communicating with the first candidate cell. Such methods include performing) an L1/L2 mobility procedure towards the first candidate cell and communicating in the first candidate cell based on the first TCI state. Other embodiments include complementary methods for serving and candidate DUs, as well as UEs and DUs configured to perform such methods.

### TECHNICAL FIELD

The present application relates generally to the field of wireless networks, and more specifically to improving mobility of user equipment (UEs) across multiple cells in a wireless network, specifically to cells provided by different distributed units (DUs) that may be associated with a single centralized unit (CU).

### INTRODUCTION

Currently the fifth generation (5G) of cellular systems is being standardized within the Third-Generation Partnership Project (3GPP). 5G is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in EPC 198 via respective S1-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU. e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. As such. each of the CUS and DUs can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

FIG. 2 shows an exemplary configuration of NR user plane (UP) and control plane (CP) protocol stacks between a UE (210), a gNB (220), and an AMF (230). The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side), PHY provides transport channel services to MAC and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE must perform a random-access (RA) procedure to move from RRC_IDLE to RRC_CONNECTED state, where the cell serving the UE is known and an RRC context is established for the UE in the serving gNB, such that the UE and gNB can communicate. As part of (or in conjunction with) the RA procedure, the UE also transmits an RRCSetupRequest message to the serving gNB.

Long-Term Evolution (LTE) Rel-10 introduced support for channel bandwidths larger than 20 MHz, which continues into NR. To remain compatible with legacy UEs from earlier releases (e.g., Rel-8), a wideband LTE Rel-10 carrier appears as multiple component carriers (CCs), each having the structure of an Rel-8 carrier. The Rel-10 UE can receive multiple CCs based on Carrier Aggregation (CA). The CCs can also be considered “cells”, such that a UE in CA has one primary cell (PCell) and one or more secondary cells (SCells). These are referred to collectively as a “cell group”. NR also supports CA starting in Rel-15.

As specified in 3GPP document RP-213565, NR Rel-18 includes a Work Item on NR mobility enhancements, including in the technical area of L1/L2 based inter-cell mobility. When the UE moves between the coverage areas of two cells, a serving cell change needs to be performed at some point. Currently, serving cell change is triggered by layer 3 (L3, e.g., RRC) measurements and involves RRC signaling to change PCell and PSCell (e.g., when dual connectivity is configured), as well as release/add SCells (e.g., when CA is configured).

Currently, all inter-cell mobility involves complete layer 2 (L2) and layer 1 (L1, i.e., PHY) resets, leading to longer latency, increased signaling overhead, and longer interruptions than for intra-cell beam switching. Thus, a goal of Rel-18 L1/L2 mobility enhancements is to facilitate serving cell changes via L1/L2 signaling to address these problems and/or difficulties.

### SUMMARY

These Rel-18 L1/L2 mobility enhancements also must consider the split CU/DU architecture shown in FIG. 1 and discussed above, including for intra-DU and inter-DU/intra-CU cell changes in which the UE's source and target cells are served by different source and target DUs associated with a single CU. However, there are various problems, issues, and/or difficulties.

For example, since one of the goals in L1/L2 inter-cell mobility is to reduce the interruption time for UE data transmissions, the UE needs to be ready to communicate with the target cell upon (or shortly after) receiving the L1/L2 signaling for mobility execution from the source cell. As a more specific example, the UE must be able to transmit UL data or a scheduling request (SR) to the target cell and/or monitor a DL control channel (e.g., PDCCH) from the target cell. Currently, however, UEs do not have necessary information about target cell configuration (e.g., TCI state) to initiate communication in a way that meaningfully reduces interruption time.

An object of embodiments of the present disclosure is to address these and related problems, issues, and/or difficulties, thereby facilitating UE L1/L2 mobility between cells in a RAN (e.g., NG-RAN).

Some embodiments of the present disclosure include methods (e.g., procedures) for a UE configured to communicate with a RAN node comprising a CU and a DU that provides a serving cell for the UE.

These exemplary methods include receiving, from the DU, a lower layer signalling message indicating that the UE should perform L1/L2-based inter-cell mobility to a first candidate cell provided by a candidate DU. The lower layer signaling message includes an indicator or identity of the first candidate cell, and an indication of a first TCI state to be used by the UE for communicating with the first candidate cell. These exemplary methods also include performing an L1/L2 mobility procedure towards the first candidate cell and communicating in the first candidate cell based on the first TCI state.

In some embodiments, the indication of the first TCI state is a TCI state identifier. In other embodiments, the indication of the first TCI state is an index of a first beam or reference signal (RS) transmitted in the first candidate cell.

In some of these embodiments, these exemplary methods also include receiving, from the CU via the DU, an RRCReconfiguration message that includes configurations associated with one or more candidate cells for L1/L2-based inter-cell mobility, including the first candidate cell. Each candidate cell configuration includes a plurality of TCI state configurations, and each TCI state configuration includes an index of a beam or RS arranged as a quasi-co-location (QCL) source. In such embodiments, these exemplary methods also include selecting as the first TCI state one of the TCI state configurations that includes the index of the first beam or RS as a QCL source.

Other embodiments include methods (e.g., procedures) for a DU of a RAN node that is coupled to a CU of the RAN node and configured to provide a serving cell for UEs.

These exemplary methods include selecting a first candidate cell, provided by a candidate DU, for L1/L2-based inter-cell mobility of a UE being served by DU via the serving cell. These exemplary methods also include sending to the UE a lower layer signalling message indicating that the UE should perform L1/L2-based inter-cell mobility to the first candidate cell. The lower layer signaling message includes an indicator or identity of the first candidate cell, and an indication of a first TCI state to be used by the UE for communicating with the first candidate cell.

In some embodiments, these exemplary methods can also include receiving, from the UE, results of measurements performed by the UE on a plurality of beams or RS transmitted in the first candidate cell. The measurement results include respective indices of the plurality of beams or RS. In some of these embodiments, the plurality of beams or RS include one or more of the following: SSBs, and CSI-RS. In some of these embodiments, the first TCI state is associated with a first beam or RS having measurement results that are most favorable (e.g., highest SS-RSRP) for L1/L2 mobility to the first candidate cell.

In some embodiments, the indication of the first TCI state is the index of the first beam or RS. In other of these embodiments, the indication of the first TCI state is a TCI state identifier. In some embodiments, the candidate DU is associated with the CU and/or is part of the RAN node.

Other embodiments include methods (e.g., procedures) for a candidate DU configured to communicate with a CU of a RAN node.

These exemplary methods include receiving, from the CU or from a DU serving a UE via a serving cell, a request to configure the UE with at least one candidate cell for L1/L2-based inter-cell mobility. These exemplary methods also include sending, to the CU or the DU, a configuration for one or more candidate cells provided by the candidate DU, including the first candidate cell. These exemplary methods also include receiving, from the DU, a message indicating an L1/L2 mobility procedure by the UE. The message includes an indicator or identity of the first candidate cell for the UE's L1/L2-based inter-cell mobility, and an indication of a first TCI state to be used by the UE for communicating with the first candidate cell. These exemplary methods also include communicating with the UE in the first candidate cell based on the first TCI state.

In some embodiments, the candidate DU is associated with the CU and/or is part of the RAN node. In some embodiments, the indicator or identity of the first candidate cell and the indication of the first TCI state are received in a copy or encapsulation of a lower layer signaling message sent by the DU to the UE.

In some embodiments, the indication of the first TCI state is an index of a first beam or RS transmitted in the candidate cell. In such embodiments, these exemplary methods can also include determining the first TCI state, or an identifier thereof, based on the index of the first beam or RS and a mapping between TCI state identifiers used in the first candidate cell and indices of beams or RS transmitted in the first candidate cell. In other embodiments, the indication of the first TCI state is a TCI state identifier.

Other embodiments include UEs and DUs configured to perform operations corresponding to any of the exemplary methods described herein. Other embodiments also include non-transitory, computer-readable media storing computer-executable instructions that, when executed by processing circuitry, configure such UEs and DUs to perform operations corresponding to any of the exemplary methods described herein. These and other embodiments described herein can facilitate execution of L1/L2 inter-cell mobility more quickly than the existing L3-based inter-cell mobility since the execution phase is separated from the preparation phase, so that timing of lower layer signaling triggering execution of L1/L2 inter-cell mobility is up to the discretion of the serving DU. These advantages are enabled by providing the UE with a TCI state ID or an SSB index for the candidate cell in the lower layer signaling that triggers execution of L1/L2 inter-cell mobility, thereby facilitating timely UE communication with the candidate cell. Furthermore, by providing a UE with an indication of whether to perform a MAC reset in conjunction with the L1/L2 inter-cell mobility, embodiments avoid data losses and excess interruptions when MAC resets are unnecessary. At a high level, embodiments improve UE mobility in RANs.

These and other objects, features, and advantages of the present disclosure will become apparent upon reading the following Detailed Description in view of the Drawings briefly described below.

### BRIEF DESCRIPTION OF THE DRAWINGS

FIG. 1 shows a high-level view of an exemplary 5G network architecture.

FIG. 2 shows an exemplary configuration of NR UP and CP protocol stacks.

FIGS. 3-4 show logical architectures for a gNB arranged in the split CU/DU architecture illustrated by FIG. 1.

FIG. 5 shows a signaling flow for an inter-DU/intra-CU mobility procedure for a UE.

FIG. 6, which includes FIGS. 6A-F, shows various ASN.1 data structures for configuring a UE with L1/L2 inter-cell mobility candidates, according to various embodiments of the present disclosure.

FIGS. 7-10 show signaling diagrams of procedures for configuring a UE for inter-DU L1/L2 inter-cell mobility from a serving DU to a candidate DU, both associated with the same CU, according to various embodiments of the present disclosure.

FIG. 11 shows an exemplary method (e.g., procedure) for a UE, according to various embodiments of the present disclosure.

FIG. 12 shows an exemplary method (e.g., procedure) for a serving DU, according to various embodiments of the present disclosure.

FIG. 13 shows an exemplary method (e.g., procedure) for a candidate DU, according to various embodiments of the present disclosure.

FIG. 14 shows a communication system according to various embodiments of the present disclosure.

FIG. 15 shows a UE according to various embodiments of the present disclosure.

FIG. 16 shows a network node according to various embodiments of the present disclosure.

FIG. 17 shows host computing system according to various embodiments of the present disclosure.

FIG. 18 is a block diagram of a virtualization environment in which functions implemented by some embodiments of the present disclosure may be virtualized.

FIG. 19 illustrates communication between a host computing system, a network node, and a UE via multiple connections, at least one of which is wireless, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally. a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description herein focuses on a 3GPP cellular communications system and. as such. 3GPP terminology or terminology similar to 3GPP terminology is generally used.

However, the concepts disclosed herein are not limited to a 3GPP system. Other wireless systems. including without limitation Wide Band Code Division Multiple Access (WCDMA). Worldwide Interoperability for Microwave Access (WiMax). Ultra Mobile Broadband (UMB) and Global System for Mobile Communications (GSM), may also benefit from the concepts, principles. and/or embodiments described herein. Furthermore, although the term “cell” is used herein, it should be understood that (particularly with respect to 5G NR) beams may be used instead of cells and, as such, concepts described herein apply equally to both cells and beams.

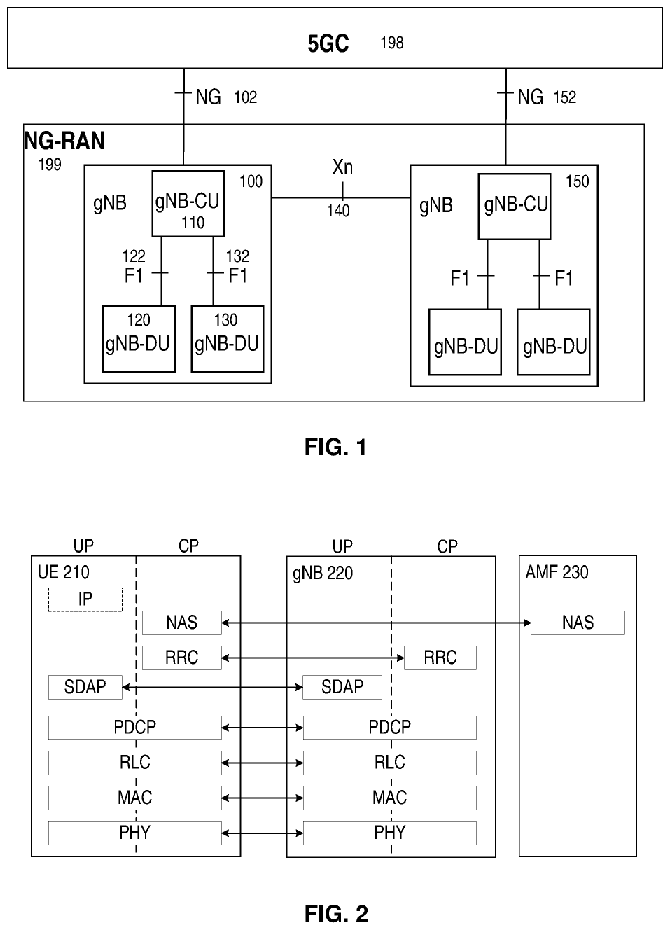

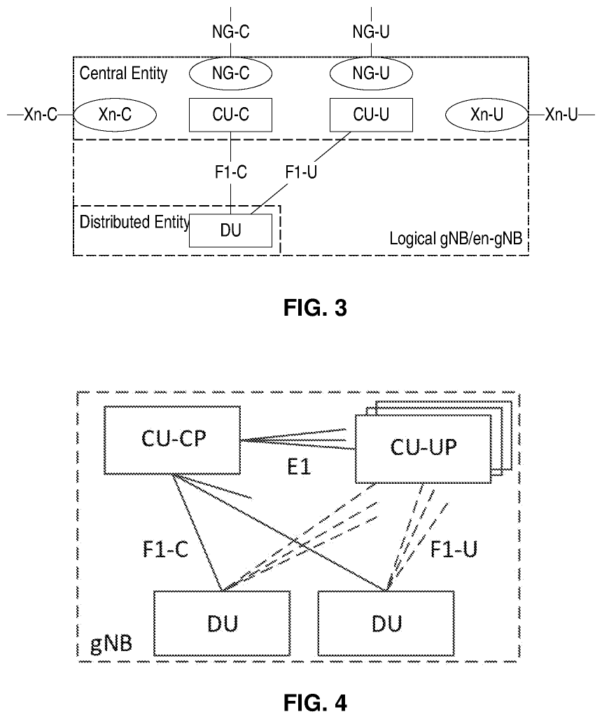

FIG. 3 shows a logical architecture for a gNB arranged in the split CU/DU architecture. such as the gNB (100) in FIG. 1. This logical architecture separates the CU into CP and UP functionality, called CU-C and CU-U respectively. Furthermore, each of the NG, Xn, and F1 interfaces is split into a CP interface (e.g., NG-C) and a UP interface (e.g., NG-U). Note that the terms “Central Entity” and “Distributed Entity” in FIG. 3 refer to physical network nodes.

FIG. 4 shows another exemplary gNB logical architecture that includes two gNB-DUs, a gNB-CU-CP, and multiple gNB-CU-UPs. The gNB-CU-CP may be connected to the gNB-DU through the F1-C interface, and the gNB-CU-UP may be connected to the gNB-DU through the F1-U interface and to the gNB-CU-CP through the E1 interface. Each gNB-DU may be connected to only one gNB-CU-CP, and each gNB-CU-UP may be connected to only one gNB-CU-CP. One gNB-DU may be connected to multiple gNB-CU-UPs under the control of the same gNB-CU-CP. Also, one gNB-CU-UP may be connected to multiple DUs under the control of the same gNB-CU-CP. When referring herein to an operation performed by a “CU”, it should be understood that this operation can be performed by any entities within the CU (e.g., CU-CP, gNB-CU-CP) unless stated otherwise.

When a UE moves between the coverage areas of two cells, a serving cell change needs to be performed at some point. Currently, serving cell change is triggered by layer 3 (L3, e.g., RRC) measurements and involves RRC signaling to change PCell and PSCell (e.g., when dual connectivity is configured), as well as release/add SCells (e.g., when CA is configured). Currently, all inter-cell mobility involves complete layer 2 (L2) and layer 1 (L1, i.e., PHY) resets. This includes inter-DU/intra-CU cell changes, where the UE's source and target cells are served by different source and target DUs associated with a single CU.

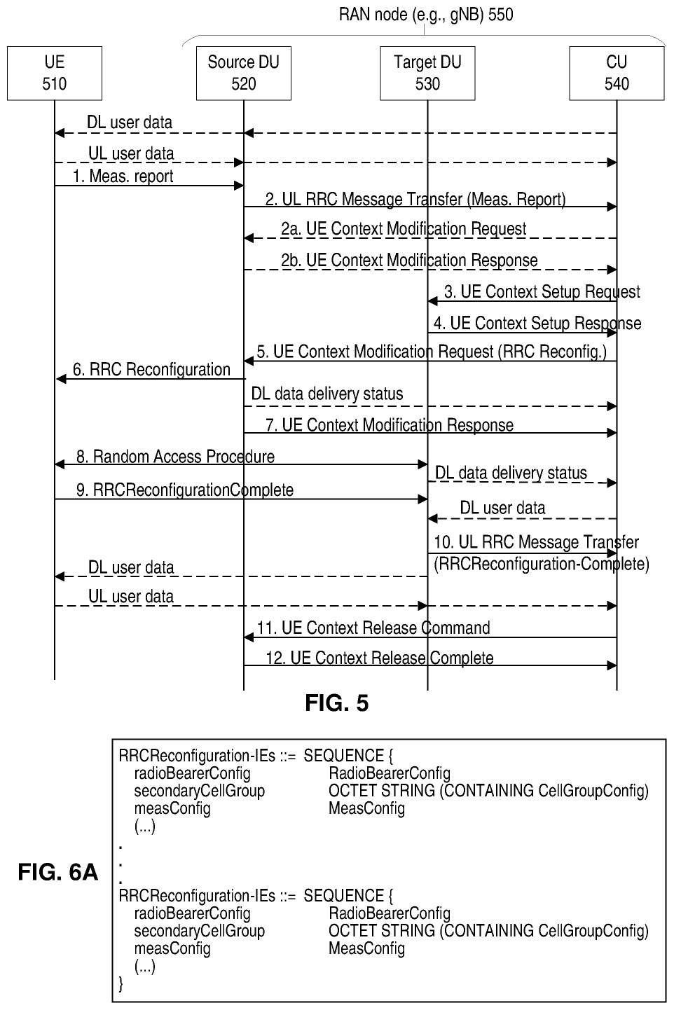

FIG. 5 shows a signaling flow for an inter-DU/intra-CU mobility procedure for a UE (510), where the source DU (520) and target DU (530) are associated with the same CU (540), i.e., part of a single RAN node (550)), such as a gNB. Although the operations shown in FIG. 5 are given numerical labels, this is done to facilitate explanation rather than to require or imply any operational order, unless expressly stated otherwise.

In operation 1, the UE sends a MeasurementReport message to the source DU. In operation 2, the source DU sends an UL RRC MESSAGE TRANSFER message to the CU to convey the received MeasurementReport message. In operation 2a (which is optional), the CU may send a UE CONTEXT MODIFICATION REQUEST message to the source DU to query the latest configuration. In operation 2b, the source DU responds with a UE CONTEXT MODIFICATION RESPONSE message that includes full configuration information.

In operation 3, the CU sends a UE CONTEXT SETUP REQUEST message to the target DU to create a UE context and setup one or more data bearers. The UE CONTEXT SETUP REQUEST message includes a HandoverPreparationInformation. In operation 4, the target DU responds to the CU with a UE CONTEXT SETUP RESPONSE message.

In operation 5, the CU sends a UE CONTEXT MODIFICATION REQUEST message to the source DU, which includes a generated RRC′Reconfiguration message and indicates to stop the data transmission for the UE. The source DU also sends a Downlink Data Delivery Status frame to inform the CU about the unsuccessfully transmitted downlink data to the UE. In operation 6, the source DU forwards the received RRCReconfiguration message to the UE. In operation 7, the source DU responds to the CU with the UE CONTEXT MODIFICATION RESPONSE message.

In operation 8, the UE performs a random access procedure is performed at the target DU. The target DU sends a Downlink Data Delivery Status frame to inform the CU. Downlink packets, which may include PDCP PDUs not successfully transmitted in the source DU, are sent from the CU to the target DU. It is up to CU implementation whether to start sending DL User Data to DU before or after reception of the Downlink Data Delivery Status.

In operation 9, the UE responds to the target DU with an RRCReconfigurationComplete message. In operation 10, the target DU sends an UL RRC MESSAGE TRANSFER message to the CU to convey the received RRCReconfigurationComplete message. Downlink packets are sent to the UE. Also, uplink packets are sent from the UE, which are forwarded to the CU through the target DU. In operation 11, the CU sends a UE CONTEXT RELEASE COMMAND message to the source DU. In operation 12, the source DU releases the UE context.

As briefly mentioned above, NR Rel-18 includes a Work Item on NR mobility enhancements, including the technical area of L1/L2 based inter-cell mobility. A goal of Rel-18 L1/L2 mobility enhancements is to facilitate serving cell changes via L1/L2 signaling instead of L3 (e.g., RRC) signaling. One area of interest is inter-DU/intra-CU cell changes, such as shown in FIG. 5 above. From the UE perspective, the procedure shown in FIG. 5 can involve longer latency, increased signaling overhead, and longer interruptions than for intra-cell beam switching.

Accordingly, a high-level goal of the Rel-18 L1/L2 mobility enhancements is to facilitate serving cell change via L1/L2 signaling to address these problems and/or difficulties. Some more specific goals include:
Configuration and maintenance for multiple candidate cells to allow fast application of configurations for candidate cells;
Dynamic switch mechanism among candidate serving cells (including SpCell and SCell) for the potential applicable scenarios based on L1/L2 signalling;
L1 enhancements for inter-cell beam management, including L1 measurement and reporting, and beam indication;
Timing Advance management; and
CU-DU interface signaling to support L1/L2 mobility, if needed.

These Rel-18 L1/L2 mobility enhancements also must consider the split CU/DU architecture shown in FIGS. 1 and 3-4, including for intra-DU and inter-DU/intra-CU cell changes. In the inter-DU/intra-CU scenario, the candidate cell for L1/L2 inter-cell mobility is a cell served by a neighbor DU to the (serving or source) DU that currently provides the UE's PCell (or PSCell, for SCG change in DC).

As illustrated in FIG. 5, the execution of the L3 mobility is triggered by the source DU transmitting to the UE an RRCReconfiguration message (operation 6) that was generated by and received from the CU during the preparation phase. This message is based on the CU requesting the target DU to set up a UE context and provide the target cell configuration (e.g., CellGroupConfig) to the CU. Hence, when the target DU receives UE CONTEXT SETUP REQUEST (operation 3), it knows the UE will be arriving in the target cell shortly after it receives the RRCReconfiguration from the CU via the source DU, so that any target cell resources reserved for the incoming UE will be used shortly.

Since one of the goals in L1/L2 inter-cell mobility is to reduce the interruption time for UE data transmissions, the UE needs to be ready to communicate with the target cell upon (or shortly after) receiving the L1/L2 signaling for mobility execution from the source cell. For example, the UE must be able to transmit UL data or a scheduling request (SR) to the target cell and/or monitor a DL control channel (e.g., PDCCH) from the target cell. In other words, UE needs to know the target cell that it is moving to so it can apply the corresponding configuration, including the correct transmission configuration indicator (TCI) state for the cell. Likewise, when the source DU transmits the L1/L2 signaling for mobility execution, the target DU needs to be prepared for scheduling UL and DL transmissions for the UE in the target cell, and for receiving scheduling requests (SR) from the UE.

Each TCI state includes parameters for configuring a quasi-co-location (QCL) relationship between one or more source DL reference signals (RS, e.g., SSB) and one or more other DL RS such as DM-RS ports of physical DL shared channel (PDSCH) or physical DL control channel (PDCCH) or channel state information RS (CSI-RS) ports of a DL CSI-RS resource. In general, different DL RS can have a QCL relationship when their respective antenna ports in the base station transmitter satisfy the condition that properties of a channel over which a symbol on one antenna port is conveyed can be inferred from the channel over which a symbol on the other antenna port is conveyed.

Currently, however, the UE does not have necessary information about target cell configuration (e.g., TCI state) to initiate communication in a way that meaningfully reduces interruption time.

Embodiments of the present disclosure address these and other problems, difficulties, and/or issues by providing flexible and efficient signaling techniques in which a UE receives lower layer signaling, from a source DU serving the UE's source cell, to initiate execution of L1/L2 inter-cell mobility for a target candidate cell configured for the UE. The lower layer signaling includes information about a TCI state of the target candidate cell. The target cell is served by a target DU that is associated with the same CU as the source DU.

In some embodiments, the information is a TCI state identifier (ID), from which the UE can directly determine the TCI state configuration of the target candidate cell to use during L1/L2 inter-cell mobility execution. In this case, the source DU has a mapping between TCI state IDs and SSB indices for the target cell (e.g., provided by the target DU serving the target cell via CU) and receives measurement reports from the UE that include SSB indices of the target cell. Based on this information, the source DU can select an SSB index for the target cell, determine a corresponding TCI state ID, and provide this information to the UE in the lower layer signaling.

In other embodiments, the information is an SSB index that identifies a source RS (i.e., SSB) for a QCL source for a TCI state. Based on the target cell configuration and the SSB index, the UE selects the TCI state of the target cell to use during L1/L2 inter-cell mobility execution. In particular, the UE selects the TCI state configuration in which the indicated SSB index is configured as QCL source.

In some embodiments, the lower layer signaling can also include an indication of whether the UE should perform a MAC reset when executing the L1/L2 inter-cell mobility procedure.

Embodiments can provide various benefits and/or advantages. For example, embodiments can facilitate execution of L1/L2 inter-cell mobility much faster than existing L3-based inter-cell mobility since the execution phase is separated from the preparation phase, so that timing of the lower layer signaling that triggers execution of L1/L2 inter-cell mobility is at the discretion of the source DU. These advantages are enabled by providing the UE with a TCI state ID or an SSB index for the candidate cell in the lower layer signaling that triggers execution of L1/L2 inter-cell mobility, which facilitates timely UE communication with the candidate cell. Furthermore, by providing the UE with an indication of whether the UE should perform a MAC reset in conjunction with the L1/L2 inter-cell mobility procedure, embodiments can avoid data losses and excess interruptions when MAC resets are unnecessary. At a high level, embodiments improve mobility in RANs (e.g., NG-RANs).

In the present disclosure, the following terms may be used interchangeably: “L1/L2 based inter-cell mobility” (as used in the 3GPP Work Item), “L1/L2 mobility,” “L1-mobility,” “L1 based mobility,” “L1/L2-centric inter-cell mobility,” “L1/L2 inter-cell mobility,” “inter-cell beam management,” and “inter-DU L1/L2 based inter-cell mobility”. These terms refer to a scenario in which a UE receives lower layer (i.e., below RRC, such as MAC or PHY) signaling from a network indicating for the UE to change of its serving cell (e.g., PCell) from a source cell to a target cell. Exemplary lower layer signaling includes L1 DL control information (DCI) and L2 MAC control element (CE). Compared to conventional RRC signaling, lower layer signaling reduces processing time and interruption time during mobility and may also increase mobility robustness since the network can respond more quickly to changes in the UE's channel conditions.

In the present disclosure, the following terms may be used interchangeably with respect to L1/L2 inter-cell mobility: “neighbor DU,” “non-Serving DU,” “candidate DU,” and “target DU.” Likewise, the following terms may be used interchangeably with respect to L1/L2 inter-cell mobility: “serving DU” and “source DU”.

Another relevant aspect in L1/L2 inter-cell mobility is that a cell can be associated with multiple SSBs (or beams), with different SSBs being transmitted in different spatial directions during a half frame, thereby spanning the coverage area of a cell. A cell may also be associated with multiple CSI-RS resources, which may be transmitted in different spatial directions. Hence, in L1/L2 inter-cell mobility, the reception of lower layer signaling indicating for the UE to change from one beam in its serving cell to another beam in a (candidate) neighbor cell, which also involves changing serving cell.

The following description refers to a configuration of a L1/L2 based inter-cell mobility candidate cell (also referred to as “candidate cell configuration”), generated by a candidate DU and encapsulated in an RRCReconfiguration message received by the UE when being configured with inter-DU L1/L2 inter-cell mobility. The RRCReconfiguration message may include one or more of these configurations for respective one or more candidate cells served by the candidate DU. Each configuration includes the parameters and/or settings that the UE needs to operate in a corresponding candidate cell upon receiving lower layer signaling indicating a L1/L2 based inter-cell mobility to that candidate cell, which becomes the target cell for mobility at that point.

A configuration of an L1/L2 based inter-cell mobility candidate cell can include parameters of a serving cell (or multiple serving cells), comprising one or more of the groups of parameters within the SpCellConfig information element (IE) (or SCellConfig IE, in the case of an SCell). These parameters can include any of the following:
cell index (e.g., encoding fewer bits than the cell identifier of the L1/L2 inter-cell mobility candidate cell). That may be a field ‘servCellIndex’ or ‘candidateCellIndex’ of IE ‘ServCellIndex’ or IE ‘CandidateCellIndex’. After this being configured, the index may be later used in lower layer signaling to indicate to the UE that this is the candidate cell the UE needs to move to in the L1/L2 inter-cell mobility procedure, and/or in an RRC message indicating some operation in that particular candidate cell.
UE (e.g., UE-specific or UE-dedicated) cell configuration corresponding to the configuration of a L1/L2 based inter-cell mobility candidate cell, with parameters possibly adjusted for the UE according to UE capabilities. The UE cell configuration may include parameters defined in the ServingCellConfig IE (defined in 3GPP TS 38.331) such as DL and UL frequency configurations (including Bandwidth parts), L1 control channels (such as PDCCH, CORESETs, PUCCH), L1 data channels (such as PDSCH, PUSCH), etc.
common cell configuration corresponding to the configuration of a L1/L2 based inter-cell mobility candidate cell in the ServingCellConfigCommon IE. That may be provided within the ReconfigurationWithSync IE or separately. This common cell configuration contains, for example, a RA configuration for the UE to access the candidate cell, if necessary.
Radio Link Failure configuration(s) such as values for timer T310, counter N310, counter N311, timer N311.
At least one UE identifier to identify the UE in the L1/L2 based inter-cell mobility candidate cell such as a Cell Radio Network Temporary Identifier (C-RNTI).

In some embodiments, when the UE is configured with multiple L1/L2 inter-cell mobility candidate cells provided by the neighbor DU, the neighbor DU generates and sends to the CU, multiple sets of parameters within multiple SpCellConfig IEs. For example, the UE may receive a list of SpCellConfig IEs, one for each L1/L2 inter-cell mobility candidate.

In some embodiments, the configuration of a L1/L2 based inter-cell mobility candidate cell of the neighbor DU may be the SpCell configuration provided as part of a cell group configuration (e.g., PCell for MCG), and may also include one or more SCell configurations and cell group-specific configurations (e.g., cell group identity, cell group PHY configuration, cell group MAC configuration, simultaneous TCI state configurations for the cell group, etc.). In these embodiments, the UE is configured with a cell group configuration per neighbor DU candidate cell. One alternative is the UE to receive one configuration per cell group, where the configuration of a L1/L2 based inter-cell mobility candidate cell is the SpCell candidate configuration within that group. Then, the lower layer signaling indicates the UE to change to a configured cell group candidate, e.g., to change from an MCG configuration A to an MCG configuration B.

In some embodiments, when the UE is configured with multiple L1/L2 inter-cell mobility candidates, the neighbor DU generates and sends to the CU multiple cell group configurations, each associated with a different candidate. For example, the neighbor DU can generate and send a list of CellGroupConfig IEs.

In some embodiments, an L1/L2 inter-cell mobility candidate may be in the same frequency as the current PCell, or in a different frequency. In some embodiments, the L1/L2 inter-cell mobility candidate may be an SCell candidate.

RRC signaling implementation for the configuration of a L1/L2 based inter-cell mobility candidate cell can be done in different ways corresponding to various embodiments. Some examples are described below.

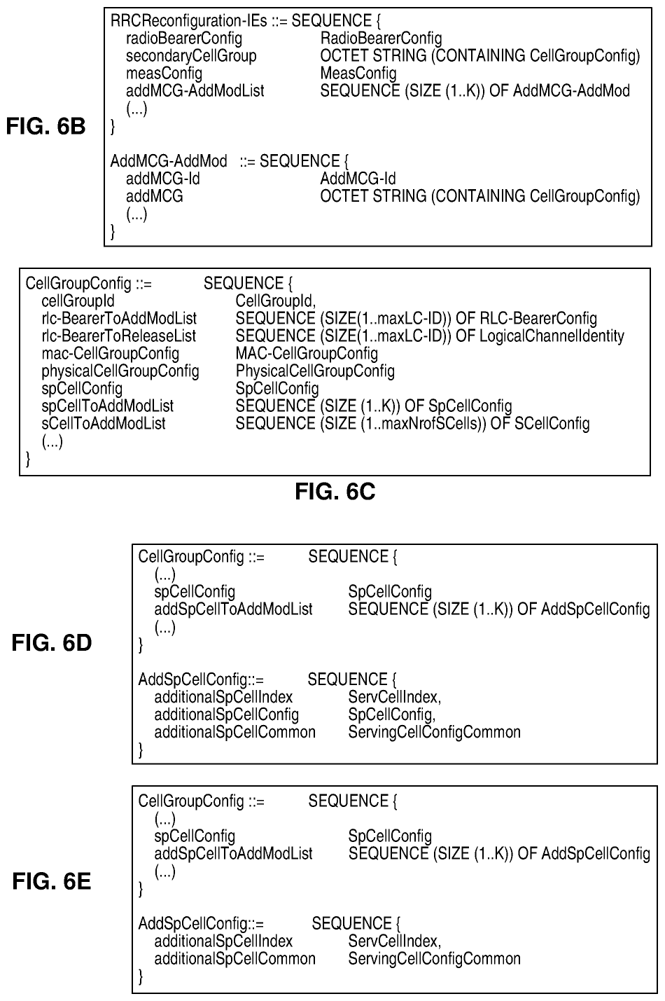

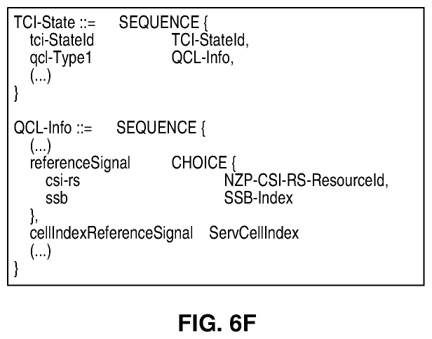

Some embodiments can utilize one RRCReconfiguration message per candidate cell. In this case the UE receives multiple (a list of) RRCReconfiguration messages within a single RRCReconfiguration message, as illustrated in FIG. 6A. Each RRCReconfiguration message identifies and/or includes a configuration of a L1/L2 based inter-cell mobility candidate cell that is stored by the UE and is applied/used/activated when receiving the lower layer signaling for the corresponding L1/L2 inter-cell mobility procedure to that candidate cell. This model enables the full flexibility, as in L3 reconfigurations, for the target node to modify/release/maintain any parameter/field in the existing RRCReconfiguration message (e.g., measurement configuration, bearers, etc.).

As an example of these embodiments, the neighbor DU generates a CellGroupConfig IE for each candidate (including candidate SpCell and SCell(s), as applicable) and the CU generates the RRCReconfiguration message per candidate based on the respective CellGroupConfig IEs. These are received by the UE and stored, to be applied if/when the UE later receives a L1/L2 inter-cell mobility command (e.g., MAC CE) indicating a particular one of the candidate cells.

Other embodiments can utilize one CellGroupConfig IE per candidate cell. With this model the UE receives within an RRCReconfiguration message a list of CellGroupConfig IEs. with each IE identifying and/or including a configuration of a L1/L2 based inter-cell mobility candidate cell. FIG. 6B shows an example of these embodiments. Each CellGroupConfig IE is stored by the UE and is applied/used/activated when receiving the lower layer signaling for the corresponding L1/L2 inter-cell mobility procedure to that candidate cell. This model allows the neighbor DU to modify/release/keep any parameter/field that is part of a CellGroupConfig IE while the rest of the RRCReconfiguration message (in which the CellGroupConfig IE is received by the UE) remains unchanged. This means that measurement configuration, bearers, securitym etc. remain the same and are not changed by the target node.

As an example of these embodiments, the neighbor DU generates the CellGroupConfig IE for each target candidate (including the candidate SpCell and SCells associated) and the CU generates the RRCReconfiguration message with the list of CellGroupConfig IEs. These are received by the UE and stored, to be applied if/when the UE later receives a L1/L2 inter-cell mobility command (e.g., MAC CE) indicating a particular one of the candidate cells.

Other embodiments can provide the UE with a plurality (K) of SpCellConfig IEs and/or a plurality (K) of ServingCellConfigCommon IEs in a configuration of a L1/L2 based inter-cell mobility candidate cell. This solution provides only minimum flexibility for the neighbor DU since only cell-specific parameters (e.g., bandwidth parts, DL/UL configurations) can be modified/released/kept by the neighbor DU when generating the K SpCellConfig IEs and/or the K ServingCellConfigCommon IEs to be provided to the UE. FIGS. 6C-E show examples of these embodiments.

Other embodiments can provide the UE with a plurality (K) of physical cell identifiers (PCI) in the same PCell. FIG. 6F shows an example of these embodiments. With this model multiple PCIs are configured for the same TCI state configuration, where each PCI identifies a configuration of an L1/L2 based inter-cell mobility candidate cell. This approach that provide no flexibility at all since all the parameters/fields used for configuring a configuration of a L1/L2 based inter-cell mobility candidate cell are fixed and only a change of PCI, scrambling Id, and/or C-RNTI is allowed for the neighbor DU.

In various embodiments, a UE has received at least one configuration for a L1/L2 based inter-cell mobility candidate cell (or candidate cell configuration), via higher-layer (e.g., RRC) signaling. The candidate cell configuration can be (or be included in) a cell group configuration (e.g., in CellGroupConfig IE) or a serving cell configuration (e.g., in ServingCellConfig and/or ServingCellConfigCommon IEs) for the candidate cell for L1/L2 inter-cell mobility. The UE may have received multiple configurations for L1/L2 based inter-cell mobility candidate cells, possibly from multiple candidate DUs serving the respective candidate cells. In some cases, the serving DU may also be a candidate DU, but the candidate cell provided by the serving DU is a different cell than the UE's serving cell.

In some embodiments, the serving (or source) DU determines to trigger L1/L2 inter-cell mobility for the UE to one of the candidate cell(s) previously configured for UE L1/L2 inter-cell mobility. The serving DU's determination can be based on one or more reports received from the UE, such as a CSI report, a measurement report, etc. Such reports can include UE measurement information pertaining to one of more of the configured candidate cells.

In some embodiments, the measurement information for an a L1/L2 inter-cell mobility candidate cell can include Synchronization Signal (SS) Reference Signal Received Power (SS-RSRP) measurements, for at least one configured/indicated SSB of the L1/L2 inter-cell mobility candidate cell. The SS-RSRP is measured only among RS comprising SSBs having the same SSB index and the same physical cell identity (PCI) as the L1/L2 inter-cell candidate cell.

In some embodiments, the SS-RSRP may be derived as a linear average over the power contributions (in [W]) of the resource elements that carry secondary synchronization signals (SSSs) of the L1/L2 inter-cell candidate cell. In some embodiments, the SS-RSRP determination can also be based on demodulation reference signals (DMRS) for physical broadcast channel

(PBCH) of the L1/L2 inter-cell candidate cell and (if indicated by higher layers) CSI-RS of the L1/L2 inter-cell candidate cell.

In one embodiment, the SS-RSRP indicate certain SSBs for performing SS-RSRP measurements, then SS-RSRP is measured only from the indicated set of SS/PBCH block(s). In some embodiments, the SS-RSRP is used for LI-RSRP to be included in a CSI report.

In some embodiments, the measurement information for an a L1/L2 inter-cell mobility candidate cell can include one of the of the following:
SS reference signal received quality (SS-RSRQ) measurements, for at least one configured/indicated SSB of the L1/L2 inter-cell mobility candidate cell:
SS signal-to-noise and interference ratio (SS-SINR) measurements, for at least one configured/indicated SSB of the L1/L2 inter-cell mobility candidate cell.
CSI-RS received power (CSI-RSRP) measurements, for at least one configured/indicated CSI-RS resource of the L1/L2 inter-cell mobility candidate cell. In some embodiment, the CSI-RSRP measurements are a linear average over the power contributions (in [W]) of the resource elements of the antenna port(s) that carry CSI-RS configured for RSRP measurements within the considered measurement frequency bandwidth in the configured CSI-RS occasions.
CSI-RS received quality (CSI-RSRQ) measurements, for at least one configured/indicated CSI-RS resource of the L1/L2 inter-cell mobility candidate cell.
CSI-RS signal-to-noise and interference ratio (CSI-SINR) measurements, for at least one configured/indicated CSI-RS resource of the L1/L2 inter-cell mobility candidate cell.
L1 reference signal received power (L1-RSRP) based on at least one SSB of a L1/L2inter-cell mobility candidate cell.
L1 reference signal received power (L1-RSRP) based on at least one CSI-RS resource of a L1/L2 inter-cell mobility candidate cell.
Layer 1 SINR (L1-SINR) based on at least one SSB of a L1/L2 inter-cell mobility candidate cell.
Layer 1 SINR (L1-SINR) based on at least one CSI-RS resource of a L1/L2 inter-cell mobility candidate cell.
Channel Quality Indicator (CQI), based on SSB and/or CSI-RS in the CSI resource configuration.
precoding matrix indicator (PMI), based on SSB and/or CSI-RS in the CSI resource configuration.
CSI-RS resource indicator (CRI), based on SSB and/or CSI-RS in the CSI resource configuration.
SS/PBCH Block Resource indicator (SSBRI), based on SSB and/or CSI-RS in the CSI resource configuration.
Layer indicator (LI), based on SSB and/or CSI-RS in the CSI resource configuration.
Rank indicator (RI), based on SSB and/or CSI-RS in the CSI resource configuration.

In some embodiments, the serving DU generates and transmits to the UE lower layer signaling (e.g., MAC CE, DCI, etc.) indicating that the UE shall perform L1/L2 inter-cell mobility to a target cell. The lower layer signaling can include indications of one or more of the following:
the candidate cell to which the UE performs L1/L2 inter-cell mobility; and,
a TCI state of the candidate cell, which the UE considers to be activated in the candidate cell for the UE's L1/L2 inter-cell mobility.

In some embodiments, the indicated candidate cell can be one of the configured candidate cells for which the UE provided reports of measurements to the serving DU, e.g., the candidate cell for which the UE indicated highest RSRP, RSRQ, and/or SINR.

In some embodiments, the indication of the candidate cell can be an identifier comprising N1 (integer) bits, which is mapped to the cell identifier of the target candidate cell with N2>N1 bits. For example, the candidate cell configuration (e.g., received earlier via RRC) can include the N1-bit identifier, so that when the UE receives the lower layer signaling including the N1-bit identifier it can match that with the corresponding candidate cell configuration.

In some embodiments, the indication of the TCI state is a TCI state identifier (ID), from which the UE can directly determine the TCI state configuration of the candidate cell to use during L1/L2 inter-cell mobility execution.

For example, the indicated TCI state can be the TCI state corresponding to the SSB index for which the UE reported the strongest measurements (e.g., SSB RSRP, SSB SINR, SSB RSRQ) for the candidate cell. This SSB index is configured as QCL source of the indicated TCI state. In other words, the serving DU receives from the UE SSB measurements for different SSB indices of the candidate cell (e.g., SS-RSRP for SSB indices=1, 5, 7) and, based on a mapping between SSB indices and TCI states (or TCI state identifiers), the serving DU determines which TCI state (or TCI state identifier) of the candidate cell to include in the lower layer signaling. The included TCI state is the one that the UE should use when it performs the L1/L2 inter-cell mobility execution.

Since the TCI state configuration of the candidate cell is generated by the candidate DU serving that cell, the serving DU needs to be aware of the mapping between SSB indexes and TCI states (or identifiers) of the candidate cell. In one option the mapping is provided to the serving DU during the mobility preparation phase, by the candidate DU via the CU. At the preparation phase, the CU requests the candidate DU to configure L1/L2 inter-cell mobility (for at least one candidate target cell) by transmitting a UE CONTEXT SETUP REQUEST including an indication this is a request for L1/L2 inter-cell mobility. The candidate DU generates and transmits to the CU the target candidate configuration, including the mapping between SSB indices (or other RS indices and/or beam identifiers) and TCI state identifiers, e.g., in an RRC container or as part of the F1AP message content/payload. The CU provides the mapping to the serving DU, so that when the serving DU receives a report with measurements of an SSB index of the candidate cell, it can map that SSB index to a TCI state (or identifier) of the candidate cell without necessarily knowing other details of that TCI state configuration.

As a more specific example, the candidate DU may provide the following mapping to the serving DU (via the CU):
SSB index=3→TCI state ID=4;
SSB index=2→TCI state ID=6;
SSB index=7→TCI state ID=2;

If the serving DU receives a report indicating that SSB index=7 is the SSB with strongest RSRP, RSRQ, and/or SINR for the candidate cell, it includes TCI state ID=2 in the lower layer signaling based on the provided mapping.

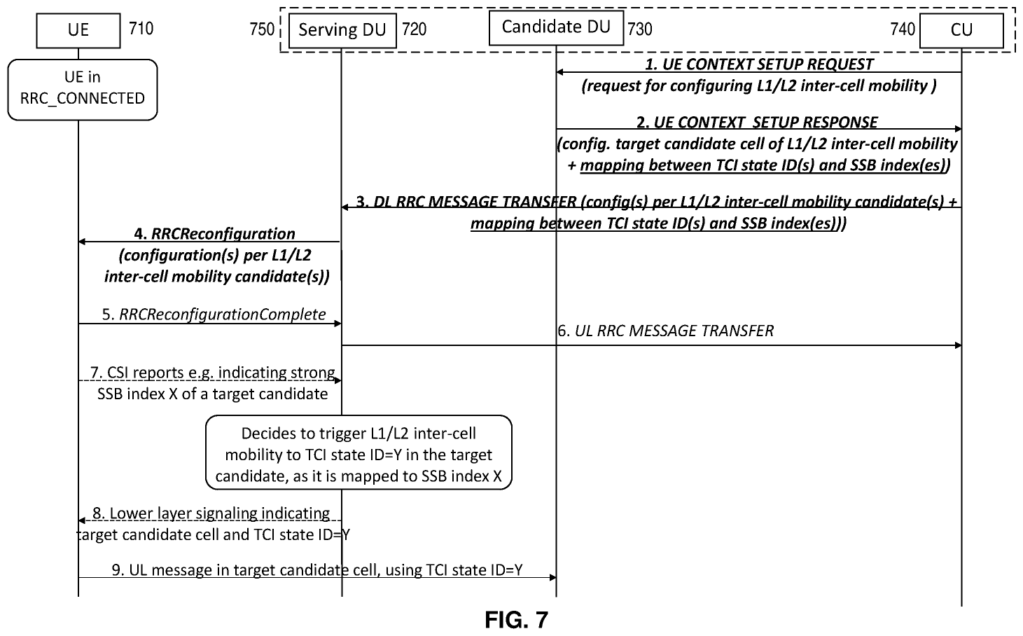

FIG. 7 shows a signaling flow for configuring a UE (710) for inter-DU L1/L2 inter-cell mobility from a serving DU (720) to a candidate DU (730), both associated with the same CU (740), according to these embodiments. In other words, the serving DU, the candidate DU, and the CU are part of a single RAN node (750). Although the operations shown in FIG. 7 are given numerical labels, this is done to facilitate explanation rather than to require or imply any particular operational order, unless expressly stated otherwise.

In operation 1, the CU sends to the candidate DU a UE CONTEXT SETUP REQUEST message including a request to configure L1/L2 inter-cell mobility for the UE. In operation 2, the candidate DU responds with a UE CONTEXT SETUP RESPONSE message including a configuration for a candidate cell served by the candidate DU, and a mapping between TCI state IDs and SSB indices for that candidate cell. In operation 3, the CU provides the same information to the UE's serving DU in a DL RRC MESSAGE TRANSFER message. If the CU has collected other candidate cell configurations (e.g., from other candidate DUs), it can include them in this message.

In operations 4-5, the serving DU sends the UE an RRCReconfiguration message that include the configurations for L1/L2 inter-cell mobility candidate cells received from the CU, and the UE responds with an RRCReconfigurationComplete message. In operation 6, the serving DU responds to the CU with an UL RRC MESSAGE TRANSFER message.

In operation 7, the UE sends the serving DU one or more CSI reports with measurements of SSBs in the candidate cell, with the strongest measurements being for SSB index=X. The serving DU decides to trigger L1/L2 inter-cell mobility of the UE to the candidate cell, and maps SSB index=X to TCI state ID=Y that based on the mapping received in operation 2. In operation 8, the serving DU sends to the UE lower layer signaling including an identifier of the candidate cell and TCI state ID=Y. In operation 9, the UE sends an UL message to the candidate DU in the candidate cell, based on applying TCI state ID=Y for the candidate cell.

In other embodiments, the indication of the TCI state is a beam configuration of the candidate cell. For example, the beam configuration can correspond to the beam or RS index for which the UE reported the strongest measurements (e.g., SSB RSRP, SSB SINR, SSB RSRQ) for the candidate cell. More specifically, this beam or RS index is configured as QCL source of the indicated beam configuration.

For example, the serving DU receives from the UE one or more measurements per RS index of the target candidate cell (e.g., RSRP for RS index=1, RSRP for RS index=5 and RSRP for RS index=7), and, based on a mapping between RS indices and beam configurations (or configuration identifiers), the serving DU determines which beam configuration (or identifier) of the candidate cell to include in the lower layer signaling to the UE. The included beam configuration is the one that the UE should use when it performs the L1/L2 inter-cell mobility execution.

Since the beam configurations of the candidate cell are generated by the candidate DU serving that cell, the serving DU needs to be aware of the mapping between beam or RS indices and beam configurations (or identifiers) of the candidate cell. This can be handled in a similar manner as a mapping between SSB indexes and TCI states (or identifiers), discussed above.

In other embodiments, the indication of the TCI state is a beam or RS index that identifies a RS (e.g., SSB) as a QCL source for a TCI state. Based on the candidate cell configuration previously received and the beam or RS index, the UE selects the TCI state of the candidate cell to use during L1/L2 inter-cell mobility execution. In particular, the UE selects the TCI state configuration in which the indicated beam or RS index is configured as QCL source.

For example, the indicated beam or RS index can be an SSB index for which the UE reported the strongest measurements (e.g., SSB RSRP, SSB SINR, SSB RSRQ) for the candidate cell. This SSB index is configured as QCL source of a particular TCI state for the candidate cell. In other words, the serving DU receives from the UE SSB measurements for different SSB indices of the candidate cell (e.g., SS-RSRP for SSB indices=1, 5, 7) and selects the SSB index corresponding to strongest measurements.

For example, the indicated TCI state can be the TCI state corresponding to the SSB index for which the UE reported the strongest measurements (e.g., SSB RSRP, SSB SINR, SSB RSRQ) for the candidate cell. This SSB index is configured as QCL source of the indicated TCI state. In other words, the serving DU receives from the UE measurements for different SSB indices of the candidate cell (e.g., SS-RSRP for SSB indices=1, 5, 7), determines that SSB index =7 has the strongest measurements, and includes SSB index=7 in the lower layer signaling to the UE.

Note that in these embodiments, the serving DU does not perform any mapping between SSB indices and TCI states. Rather, upon reception of the lower layer signaling, the UE selects a TCI state in which SSB index=7 is configured as the QCL source, according to the candidate cell configuration previously received.

For example, the candidate cell configuration generated by the candidate DU and provided to the UE includes the following TCI state configurations:
SSB index=3 as QCL source (e.g., type D)→TCI state ID=4;
SSB index=2 as QCL source (e.g., type D)→TCI state ID=6;
SSB index=7 as QCL source (e.g., type D)→TCI state ID=2;

If the serving DU receives a UE report indicating that SSB index=7 is the SSB with strongest RSRP, RSRQ, and/or SINR for the candidate cell, the serving DU includes SSB index=7 in the lower layer signaling based on the provided mapping. The UE determines based on the candidate cell configuration that it needs to use TCI state ID=2 in the candidate cell, for which SSB index=7 is a QCL source.

As mentioned above, the serving DU does not need to be aware of the mapping between SSB indexes and TCI state identifiers of the candidate cell. Thus, unlike embodiments illustrated in FIG. 7, the candidate DU does not need to provide the mapping between SSB indexes and TCI state identifiers of the candidate cell to the CU or serving DU during the preparation phase.

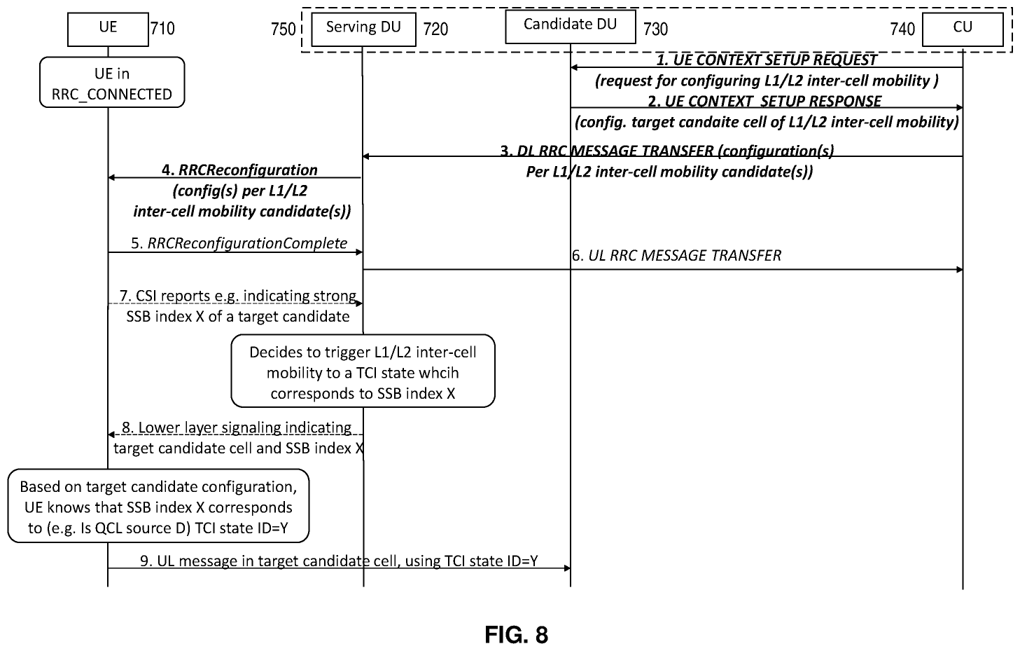

FIG. 8 shows a signaling flow for configuring a UE (710) for inter-DU L1/L2 inter-cell mobility from a serving DU (720) to a candidate DU (730), both associated with the same CU (740), according to these embodiments. In other words, the serving DU, the candidate DU, and the CU are part of a single RAN node (750). Although the operations shown in FIG. 8 are given numerical labels, this is done to facilitate explanation rather than to require or imply any particular operational order, unless expressly stated otherwise.

Operations 1-7 are similar to corresponding operations described above for FIG. 7, except that the mapping between TCI state IDs and SSB indices is not include in the messages of operations 2-3. In operation 8, the serving DU sends to the UE lower layer signaling including an identifier of the candidate cell and SSB index=X. Based on the candidate cell configuration received in operation 4, the UE selects the TCI state (represented by TCI state ID=Y) in which SSB index=X is configured as QCL source. In operation 9, the UE sends an UL message to the candidate DU in the candidate cell, based on applying TCI state ID=Y for the candidate cell.

In some embodiments, the serving DU can also include in the lower layer signaling an indication of whether the UE should perform a random access (RA) procedure when executing L1/L2 inter-cell mobility to the candidate cell. RA may not be needed when the serving cell and the candidate cell are overlapping, adjacent, or proximate. As a specific example, the serving DU may determine to switch the UE's PCell to another cell served by the same DU (e.g., a current SCell for the UE). Other conditions that can cause the serving DU to indicate need for RA in candidate cell include:
time alignment of candidate cell is different from time alignment of source cell;
time alignment timer of the candidate cell has expired; and/or
time alignment of the candidate cell is unknown.

In one example, the indication of whether the UE should perform RA can be explicit, such as a one-bit indication where “1” indicates RA is needed and “0” indicates RA is not needed. In another example, the indication of whether the UE should perform RA can be an index pointing to one of a set of preconfigured contention free random access (CRFA) resources in the candidate cell configuration for L1/L2 inter-cell mobility. The preconfigured resources can be RA preambles, RA occasions, SSB, or CSI-RS. In another example, the indication can explicitly indicate that contention based random access (CBRA) shall be used in the candidate cell in conjunction with L1/L2 mobility.

In another example, indication of whether the UE should perform RA may be an indication of whether the UE can maintain the time alignment of the serving cell when executing L1/L2 inter-cell mobility to the candidate cell. Note that an indication that the UE can maintain the same time alignment of the serving cell implicitly indicates that the UE does not need to perform RA in the candidate cell, which would involve obtaining time alignment. In some variants, the indication can further indicate whether the UE can maintain the same DL time alignment, the same UL time alignment, both, or neither.

In some embodiments, the UE can determine whether RA is needed in the candidate cell in conjunction with L1/L2 inter-cell mobility (e.g., at UE's discretion) based on one or more of following criteria:
time alignment of candidate cell is different from time alignment of source cell;
time alignment timer of the candidate cell has expired; and
time alignment of the candidate cell is unknown.

In some embodiments, when the serving DU generates and sends to the UE lower layer signaling (e.g., MAC CE, DCI) indicating that the UE should perform L1/L2 inter-cell mobility to a candidate cell, the serving DU also sends one or more of the following to the CU and/or to the candidate DU:
an indication of the candidate cell selected by the serving DU for L1/L2 inter-cell mobility of the UE, such as a cell identifier (e.g., PCI, CGI) or a configuration identifier;
an indication of a TCI state (e.g., TCI state ID, SSB index, etc.) of the candidate cell, to be used by the UE for L1/L2 inter-cell mobility; and
a copy or encapsulation of the lower layer signaling for L1/L2 inter-cell mobility that the serving DU sent or will send to the UE, which includes indications of the selected candidate cell and the TCI state.

Based on receiving such information, the candidate DU can determine that an incoming UE will use the particular TCI state in the candidate cell and communicate with the UE accordingly.

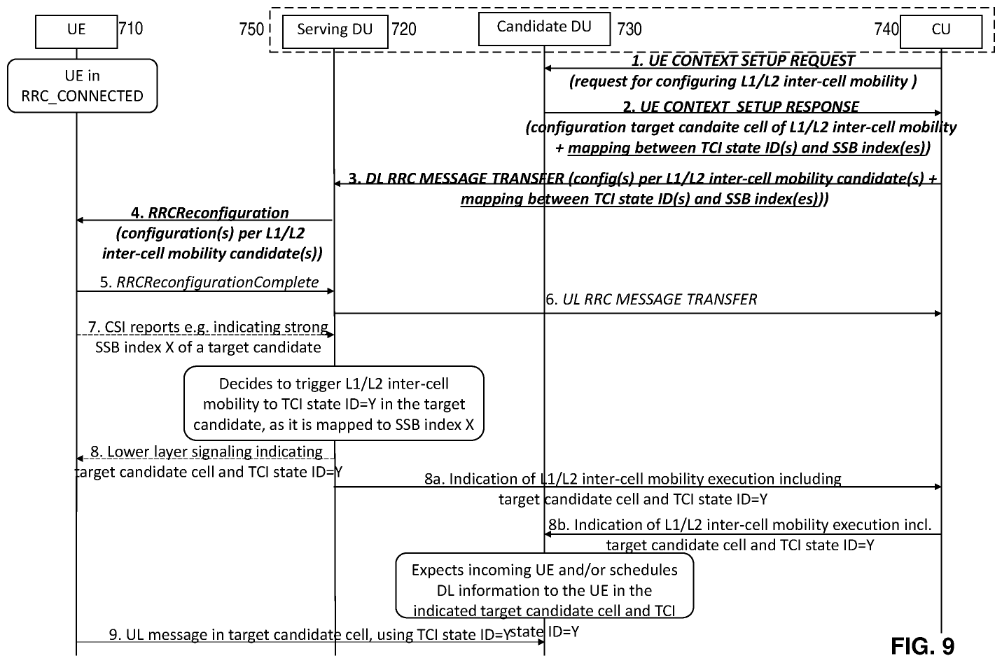

FIG. 9 shows signaling for another exemplary procedure of a CU (740) configuring a UE (710) with L1/L2 inter-cell mobility from a serving DU (720) to a candidate DU (730), both associated with the CU, according to some of these embodiments. In other words, the serving DU, the candidate DU, and the CU are part of a single RAN node (750). Since FIG. 9 shows many of the same operations as FIGS. 7-8, the descriptions of these operations in FIG. 9 will be omitted below for brevity.

In FIG. 9, the UE receives the lower layer signaling including the target candidate cell indication and the TCI state ID. The serving DU generates the TCI state ID in the lower layer signaling based on a mapping between SSB indices and TCI state IDs of the candidate cell, previously received from the candidate DU via the CU. More specifically, the serving DU determines the TCI state ID of the candidate cell based on measurement information reported from the UE for at least one SSB index of the candidate cell.

When the serving DU transmits the lower layer signaling to the UE, it also transmits an indication to the CU (including the TCI state ID), which transmits to the candidate DU. That updates the CU with the latest cell the UE connects to, but also indicates to the candidate DU that an incoming UE will be using the TCI state in the candidate cell.

The serving DU may transmit the indication of the L1/L2 inter-cell mobility (including the TCI state ID) to the CU before or after it sends the lower layer signaling to the UE, including after it has received from the UE an acknowledgement for the lower layer signaling. Alternately, the serving DU may wait a pre-determined amount of time after it sends the lower layer signaling to send the TCI state ID to the CU.

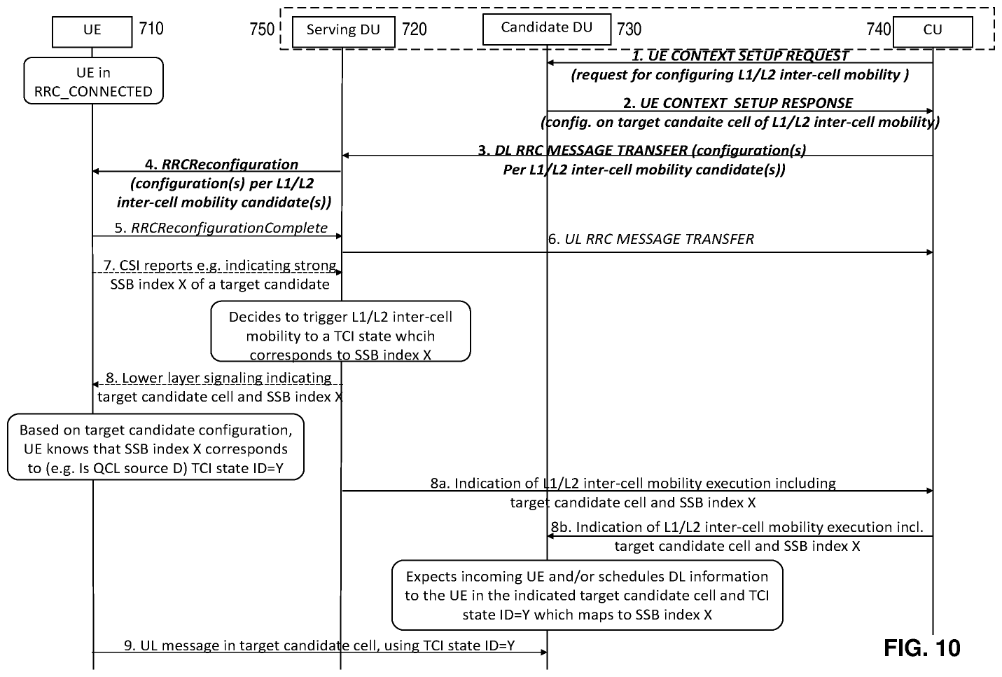

FIG. 10 shows signaling for another exemplary procedure of a CU (740) configuring a UE (710) with L1/L2 inter-cell mobility from a serving DU (720) to a candidate DU (730), both associated with the CU, according to other of these embodiments. In other words, the serving DU, the candidate DU, and the CU are part of a single RAN node (750). Since FIG. 10 shows many of the same operations as FIGS. 7-8, the descriptions of these operations in FIG. 10 will be omitted below for brevity.

In FIG. 10, the UE receives the lower layer signaling including an indication of a candidate cell and an SSB index (operation 8). The UE determines the TCI state ID of the candidate cell in execution, by activating the TCI state having the received SSB index configured as QCL source (e.g., for QCL type D or other type associated with spatial direction correlation).

When the serving DU transmits the lower layer signaling to the UE, it also transmits an indication to the CU (including SSB index), which forwards it to the candidate DU. That updates the CU with the latest cell the UE connects to, but also indicates to the candidate DU that an incoming UE will be using the SSB index (or a corresponding TCI state) in the candidate cell.

The serving DU may transmit the indication of the L1/L2 inter-cell mobility (including the SSB index) to the CU before or after it sends the lower layer signaling to the UE, including after it has received from the UE an acknowledgement for the lower layer signaling. Alternately, the serving DU may wait a pre-determined amount of time after it sends the lower layer signaling to send the SSB index to the CU.

In some variants of the embodiments shown in FIGS. 9-10, the UE does not transmit an UL message in the candidate cell (operation 9) upon receiving the lower layer signaling, but first monitors a PDCCH of the candidate cell according to the indication (e.g., TCI state ID or SSB index to be mapped to a TCI state by the UE) in the lower layer signaling. If the serving DU knows in advance that the UE first monitors a PDCCH of the candidate cell before transmitting the UL message in operation 9, the Serving DU triggers operation 8a. Otherwise, if the Serving DU is aware that the UE transmit in UL directly (operation 9), it may skip operation 8a. In the case the lower layer signaling triggers the UE to perform random access, the UE selects a beam (e.g., SSB index/CSI-RS resource identifier) and transmits a preamble associated with the selected beam, so that the candidate DU is aware of the beam the UE selects, so that the indication of which TCI state ID and/or beam ID and/or SSB index may not be needed in operation 8.

In some embodiments, upon reception of the lower layer signaling with an indication that random access procedure is not needed when executing L1/L2 inter-cell mobility to the target candidate cell, the UE starts to transmit UL messages in the target candidate cell. In this case, the first UL message that the UE could transmit in the L1/L2 inter-cell candidate cell is UL data or a scheduling request.

In some embodiments, the indication of L1/L2 inter-cell mobility execution including the candidate cell and possibly the TCI state ID and/or SSB index is provided from the serving DU to the CU (operation 8a) in a UE CONTEXT MODIFICATION REQUIRED message over F1AP. The CU provides this information to the candidate DU in a UE CONTEXT MODIFICATION REQUEST message over F1AP (operation 8b).

In some embodiments, the UE receives an indication of whether the UE should perform MAC reset when executing the L1/L2 inter-cell mobility to the candidate cell. In one example, this indication is provided within the lower layer signaling indicating the execution of L1/L2 inter-cell mobility to the candidate cell (e.g., FIG. 10 operation 8). In another example, this indication is provided within the configuration of one or more L1/L2 inter-cell mobility candidate cells (e.g., FIG. 10 operation 4). In various embodiments, a MAC reset may include one or more of the following actions:
initialize a state variable;
stop, start, or restart a timer;
set new data indictors (NDIs) for UL HARQ processes to zero;
stop an ongoing MAC procedure;
cancel a triggered MAC procedure;
flush a message buffer;
reset a counter; and
release a C-RNTI.

In some embodiments, the UE selectively performs MAC reset when executing the L1/L2 inter-cell mobility to the candidate cell, such as by performing none, some, or all of the above-listed actions. For example, this selective action is based on a received indication from the serving DU, such as the type (e.g., DCI or MAC CE) or content of the lower layer signaling indicating the execution of L1/L2 inter-cell mobility. Alternately, the indication can be part of the candidate cell configuration received via higher layer signaling.

In some embodiments, the serving DU receives, from a CU and/or from a candidate DU, an indication on whether the UE needs to perform MAC reset when executing the L1/L2 inter-cell mobility to one of the UE's configured L1/L2 inter-cell mobility candidate cells.

In some embodiments, the serving DU transmits, to a CU and/or to a candidate DU, an indication on whether the UE needs to perform MAC reset when executing the L1/L2 inter-cell mobility to one of the UE's configured L1/L2 inter-cell mobility candidate cells.

In some embodiments, the serving DU determines whether the UE needs to perform MAC reset when executing the L1/L2 inter-cell mobility to the candidate cell and sets this indication accordingly. In one example, this determination is based on a received indication from a CU and/or from a candidate DU. In another example, this determination is based on whether the source and candidate target cells are both controlled by the same DU. For example, when the source and candidate target cells are both controlled by the same DU, the indication indicates that the UE does not perform a MAC reset when executing the L1/L2 inter-cell mobility to the candidate cell. In another example, this determination is based on whether source and candidate target cells are both controlled by the same hardware or software unit.

In some embodiments, the CU transmits, to the UE, an indication on whether the UE needs to perform MAC reset when executing the L1/L2 inter-cell mobility to the candidate cell. In one example, this indication is provided within the configuration(s) of one or more L1/L2 inter-cell mobility candidate cells to be applied.

In some embodiments, the CU receives, from the serving DU or a candidate DU, an indication on whether the UE needs to perform MAC reset when executing the L1/L2 inter-cell mobility to one of the UE's configured L1/L2 inter-cell mobility candidate cells.

In some embodiments, the CU transmits, to the serving DU or a candidate DU, an indication on whether the UE needs to perform MAC reset when executing the L1/L2 inter-cell mobility to one of the UE's configured L1/L2 inter-cell mobility candidate cells.

In some embodiments, the CU determines whether the UE needs to perform MAC reset when executing the L1/L2 inter-cell mobility to the candidate cell and sets this indication accordingly. In various embodiments, this determination is based on one or more of the following:
an explicit indication from the serving DU or a candidate DU
whether source and candidate target cells are both controlled by the same DU (e.g., UE does not need to perform a MAC reset when the source and candidate cells are both controlled by the same DU).
whether source and candidate target cells are both controlled by the same hardware or software unit.

In some embodiments, the candidate DU receives, from the serving DU or a CU, an indication on whether the UE needs to perform MAC reset when executing the L1/L2 inter-cell mobility to one of the UE's configured L1/L2 inter-cell mobility candidate cells.

In some embodiments, the candidate DU transmits, to the serving DU or a CU, an indication on whether the UE needs to perform MAC reset when executing the L1/L2 inter-cell mobility to one of the UE's configured L1/L2 inter-cell mobility candidate cells.

In some embodiments, the candidate DU determines whether the UE needs to perform MAC reset when executing the L1/L2 inter-cell mobility to the candidate cell and sets this indication accordingly. In various embodiments, this determination is based on one or more of the following:
an explicit indication from the serving DU or the CU;
whether source and candidate target cells are both controlled by the same DU (e.g., UE does not need to perform a MAC reset when the source and candidate cells are both controlled by the same DU).
whether source and candidate target cells are both controlled by the same hardware or software unit.

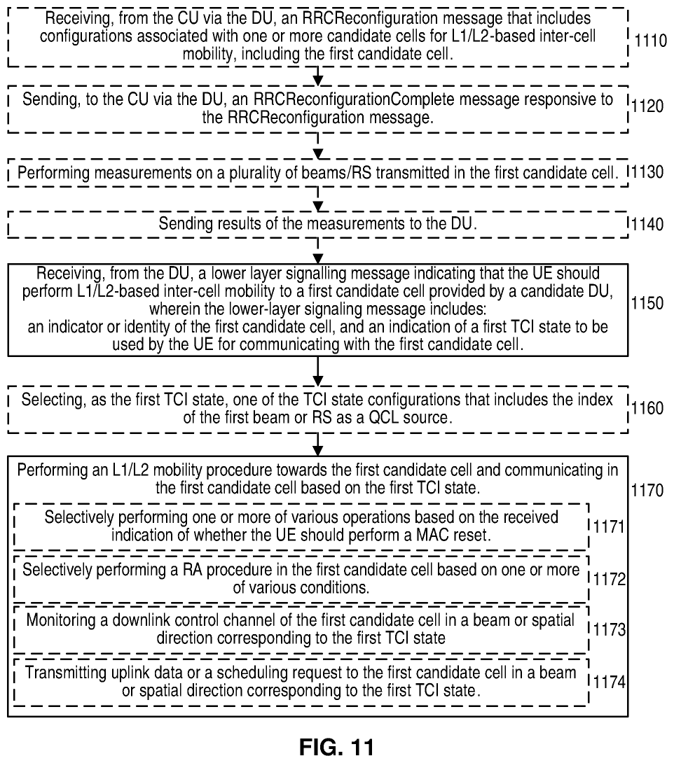

The embodiments described above can be further illustrated with reference to FIGS. 11-13, which depict exemplary methods (e.g., procedures) for a UE, a serving DU, and a candidate DU, respectively. Put differently, various features of the operations described below correspond to various embodiments described above. The exemplary methods shown in FIGS. 11-13 can be used cooperatively to provide benefits, advantages, and/or solutions to problems described herein. Although FIGS. 11-13 illustrate the exemplary methods by specific blocks in particular orders, the operations corresponding to the blocks can be performed in different orders than shown and can be combined and/or divided into blocks and/or operations having different functionality than shown. Optional blocks or operations are indicated by dashed lines.

More specifically, FIG. 11 illustrates an exemplary method (e.g., procedure) for a UE configured to communicate with a RAN node comprising a CU and a DU that provides a serving cell for the UE, according to various embodiments of the present disclosure. The exemplary method shown in FIG. 11 can be performed by a UE (e.g., wireless device) such as described elsewhere herein.

The exemplary method can include the operations of block 1150, where the UE can receive, from the DU, a lower layer signalling message indicating that the UE should perform L1/L2-based inter-cell mobility to a first candidate cell provided by a candidate DU. The lower layer signaling message includes an indicator or identity of the first candidate cell, and an indication of a first TCI state to be used by the UE for communicating with the first candidate cell. The exemplary method can also include the operations of block 1170, where the UE can perform an L1/L2 mobility procedure towards the first candidate cell and communicate in the first candidate cell based on the first TCI state.

In some embodiments, the indication of the first TCI state is a TCI state identifier or an index of a first beam or reference signal (RS) transmitted in the first candidate cell. In some of these embodiments, the exemplary method can also include the operations of blocks 1110 and 1160. In block 1110, the UE can receive, from the CU via the DU, an RRCReconfiguration message that includes configurations associated with one or more candidate cells for L1/L2-based inter-cell mobility, including the first candidate cell. Each candidate cell configuration includes a plurality of TCI state configurations, and each TCI state configuration includes an index of a beam or RS arranged as a quasi-co-location (QCL) source. In block 1160, the UE can select as the first TCI state one of the TCI state configurations that includes the index of the first beam or RS as a QCL source.

In some of these embodiments, the exemplary method can also include the operations of block 1120, where the UE can send, to the CU via the DU, an RRCReconfigurationComplete message responsive to the RRCReconfiguration message. In some of these embodiments, one of the following includes an indication of whether the UE should perform a MAC reset when executing the L1/L2 inter-cell mobility to the first candidate cell: the configuration for the first candidate cell (e.g., in block 1110), or the message compatible with lower layer signaling. In some variants of these embodiments, performing the L1/L2 mobility procedure towards the first candidate cell in block 1170 includes the operations of sub-block 1171, where the UE can selectively perform one or more of the following operations based on the indication of whether the UE should perform a MAC reset:
initializing a MAC state variable;
stopping, starting, or restarting a MAC timer;
resetting new data indictors (NDIs) for uplink hybrid ARQ processes to zero;
stopping an ongoing MAC procedure;
canceling a MAC procedure that has been triggered but is not ongoing;
flushing a MAC message buffer;
resetting a MAC counter; and
releasing a radio network temporary identifier (RNTI) assigned to the UE.

In some embodiments, the lower layer signaling message also includes an indication of whether the UE should perform a random access (RA) procedure when executing L1/L2 inter-cell mobility to the first candidate cell. In some of these embodiments, performing the L1/L2 mobility procedure towards the first candidate cell in block 1170 includes the operations of sub-block 1172, where the UE can selectively perform a RA procedure in the first candidate cell based on one or more of the following:
the indication of whether the UE should perform a RA procedure;
whether time alignment of the first candidate cell is different from time alignment of the serving cell;
whether a time alignment timer of the first candidate cell has expired; and
whether time alignment of the first candidate cell is known or unknown.

In some embodiments, the exemplary method can also include the operations of blocks 1130-1140, where the UE can perform measurements on a plurality of beams or RS transmitted in the first candidate cell and send results of the measurements to the DU. In such case, the first TCI state corresponds to an index of a beam or RS with measurement results most favorable for L1/L2 mobility to the first candidate cell. In some of these embodiments, the plurality of beams or RS include one or more of the following: synchronization signal/PBCH blocks (SSBs), and channel state information reference signals (CSI-RS).

In some embodiments, one or more of the following applies: the lower layer signaling message is for a protocol layer below the RRC protocol layer, and the lower layer signaling message is one of the following: MAC control element (CE), or physical layer downlink control information (DCI). In some embodiments, the candidate DU is associated with the CU and/or is part of the RAN node.

In some embodiments, communicating in the first candidate cell based on the first TCI state in block 1170 includes one or more of the following operations, denoted by corresponding sub-block numbers:
(1173) monitoring a downlink control channel of the first candidate cell in a beam or spatial direction corresponding to the first TCI state; and
(1174) transmitting uplink data or a scheduling request to the first candidate cell in a beam or spatial direction corresponding to the first TCI state.

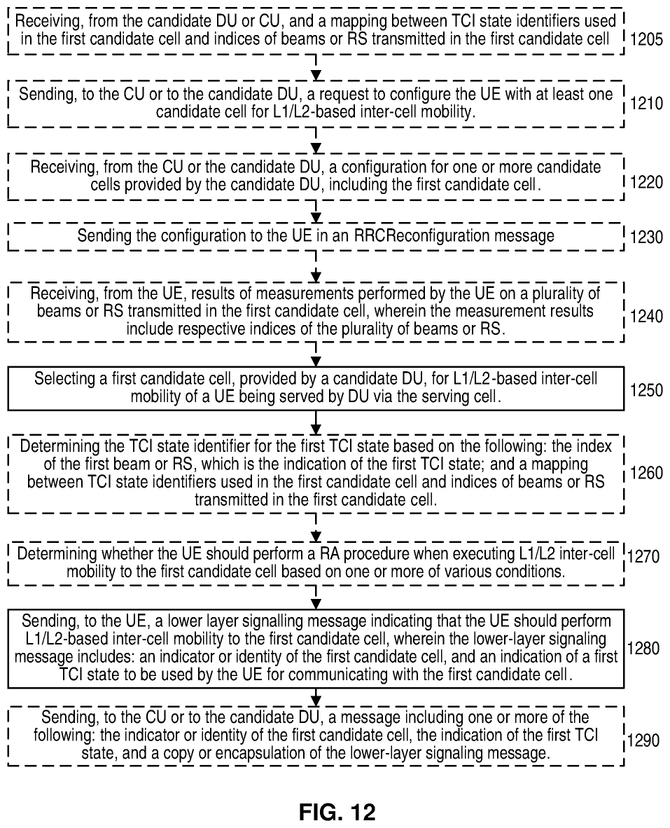

In addition, FIG. 12 illustrates an exemplary method (e.g., procedure) for a DU of a RAN node that is configured to communicate with a CU of the RAN node and to provide a serving cell for UEs, according to various embodiments of the present disclosure. The exemplary method shown in FIG. 12 can be performed by serving DUs such as described elsewhere herein.

The exemplary method can include the operations of block 1250, where the DU can select a first candidate cell, provided by a candidate DU, for L1/L2-based inter-cell mobility of a UE being served by the DU via the serving cell. The exemplary method can also include the operations of block 1280, where the DU can send to the UE a lower layer signalling message indicating that the UE should perform L1/L2-based inter-cell mobility to the first candidate cell. The lower layer signaling message includes an indicator or identity of the first candidate cell, and an indication of a first TCI state to be used by the UE for communicating with the first candidate cell.

In some embodiments, the exemplary method can also include the operations of block 1240, where the DU can receive from the UE results of measurements performed by the UE on a plurality of beams or RS transmitted in the first candidate cell. The measurement results include respective indices of the plurality of beams or RS. In some of these embodiments, the plurality of beams or RS include one or more of the following: SSBs, and CSI-RS.

In some of these embodiments, the first TCI state is associated with a first beam or RS having measurement results that are most favorable (e.g., highest SS-RSRP) for L1/L2 mobility to the first candidate cell. In some variants of these embodiments, the indication of the first TCI state is one of the following: the index of the first beam or RS, or a TCI state identifier.

In some further variants of these embodiments, the exemplary method can also include the operations of block 1260, where the DU can determine the TCI state identifier for the first TCI state based on the following: the index of the first beam or RS, which is the indication of the first TCI state; and a mapping between TCI state identifiers used in the first candidate cell and indices of beams or RS transmitted in the first candidate cell. In some further variants, the exemplary method can also include the operations of block 1205, where the DU can receive the mapping (e.g., used in block 1260) from the candidate DU or the CU.

In some embodiments, the exemplary method can also include the operations of block 1290, where the DU can send, to the CU or to the candidate DU, a message including one or more of the following:
the indicator or identity of the first candidate cell for the UE's L1/L2-based inter-cell mobility;
the indication of the first TCI state to be used by the UE for communicating with the first candidate cell; and
a copy or encapsulation of the lower layer signaling message (e.g., sent or to be sent to the UE in block 1280).

In some embodiments, the lower layer signaling message in block 1280 can also include one of more of the following:
an indication of whether the UE should perform a RA procedure when executing L1/L2 inter-cell mobility to the first candidate cell; and
an indication of whether the UE should perform a MAC reset when executing the L1/L2 inter-cell mobility to the first candidate cell.

In some of these embodiments, the exemplary method can also include the operations of block 1270, where the DU can determine whether the UE should perform a RA procedure when executing L1/L2 inter-cell mobility to the first candidate cell, as indicated in the lower layer signaling message, based on one or more of the following:
whether time alignment of the first candidate cell is different from time alignment of the serving cell;
whether a time alignment timer of the first candidate cell has expired; and
whether time alignment of the first candidate cell is known or unknown.

In some embodiments, the lower layer signaling message is for a protocol layer below the RRC protocol layer and/or the lower layer signaling message is a MAC CE or PHY DCI. In some embodiments, the candidate DU is associated with the CU and/or is part of the RAN node.

In some embodiments, the exemplary method can also include the DU performing the following operations, labelled with corresponding block numbers:
(1210) sending, to the CU or to the candidate DU, a request to configure the UE with at least one candidate cell for L1/L2-based inter-cell mobility;
(1220) receiving, from the CU or the candidate DU, a configuration for one or more candidate cells provided by the candidate DU, including the first candidate cell; and
(1230) sending the configuration to the UE in an RRCReconfiguration message.

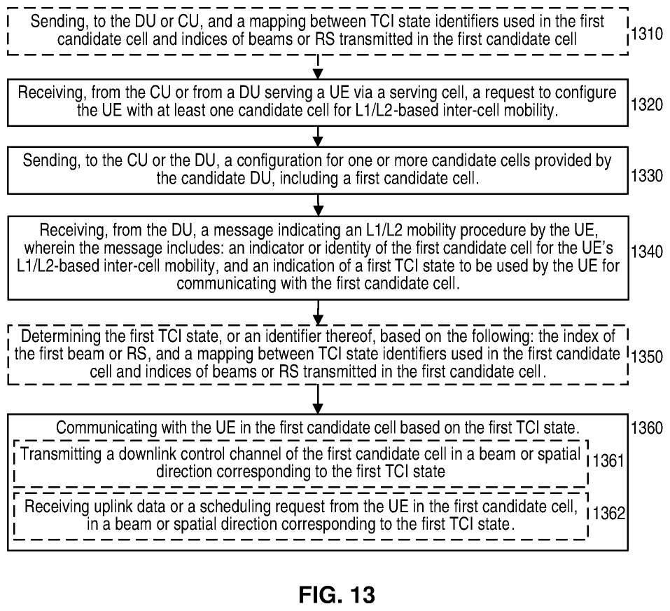

In addition, FIG. 13 illustrates an exemplary method (e.g., procedure) for a candidate DU of a RAN node, according to various embodiments of the present disclosure. The exemplary method shown in FIG. 13 can be performed by candidate DUs such as described elsewhere herein.

The exemplary method can include the operations of block 1320, where the candidate DU can receive, from the CU or from a DU serving a UE via a serving cell, a request to configure the UE with at least one candidate cell for L1/L2-based inter-cell mobility. The exemplary method can also include the operations of block 1330, where the candidate DU can send, to the CU or the DU, a configuration for one or more candidate cells provided by the candidate DU, including a first candidate cell. The exemplary method can also include the operations of block 1340, where the candidate DU can receive from the DU a message indicating an L1/L2 mobility procedure by the UE. The message includes an indicator or identity of the first candidate cell for the UE's L1/L2-based inter-cell mobility, and an indication of a first TCI state to be used by the UE for communicating with the first candidate cell. The exemplary method can also include the operations of block 1360, where the candidate DU can communicate with the UE in the first candidate cell based on the first TCI state.

In some embodiments, the DU is associated with the CU and/or is part of the RAN node. In some embodiments, the indicator or identity of the first candidate cell and the indication of the first TCI state are received in a copy or encapsulation of a lower layer signaling message sent by the DU to the UE.

In some embodiments, the indication of the first TCI state is an index of a first beam or RS transmitted in the candidate cell. In such embodiments, the exemplary method can also include the operations of block 1350, where the candidate DU can determine the first TCI state, or an identifier thereof, based on the following: the index of the first beam or RS, and a mapping between TCI state identifiers used in the first candidate cell and indices of beams or RS transmitted in the first candidate cell.

In other embodiments, the indication of the first TCI state is a TCI state identifier and the exemplary method also includes the operations of block 1310, where the candidate DU can send, to the CU or to the DU, a mapping between TCI state identifiers used in the first candidate cell and indices of beams or RS transmitted in the first candidate cell.

In some embodiments, the configuration for the first candidate cell (e.g., sent in block 1330) includes an indication of whether the UE should perform a MAC reset when executing the L1/L2 inter-cell mobility to the first candidate cell.

In some embodiments, communicating with the UE in the first candidate cell based on the first TCI state in block 1360 includes one or more of the following operations, denoted by corresponding sub-block numbers:
(1361) transmitting a downlink control channel of the first candidate cell in a beam or spatial direction corresponding to the first TCI state; and
(1362) receiving uplink data or a scheduling request from the UE in the first candidate cell, in a beam or spatial direction corresponding to the first TCI state.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

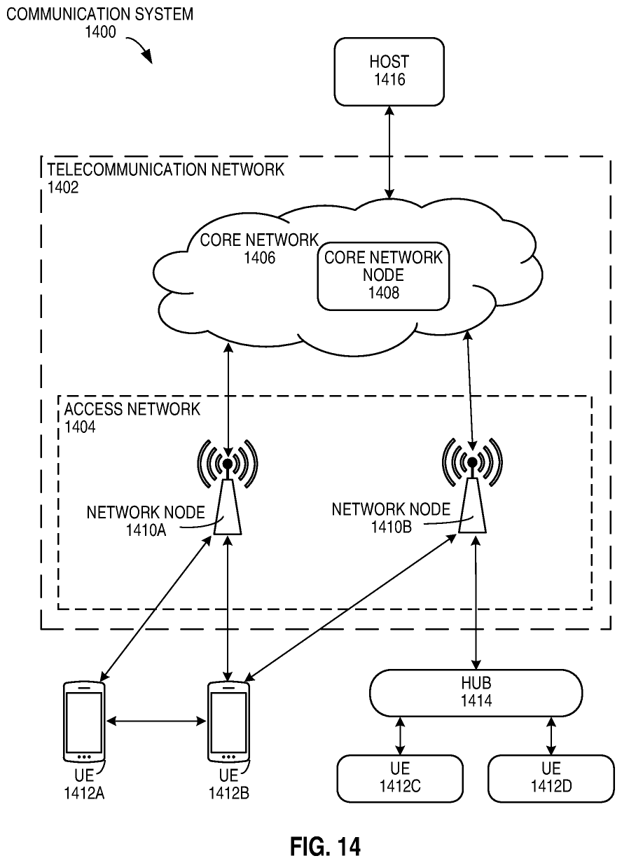

FIG. 14 shows an example of a communication system 1400 in accordance with some embodiments. In this example, communication system 1400 includes telecommunication network 1402 that includes access network 1404 (e.g., RAN) and core network 1406, which includes one or more core network nodes 1408. Access network 1404 includes one or more access network nodes, such as network nodes 1410a-b (one or more of which may be generally referred to as network nodes 1410), or any other similar 3GPP access node or non-3GPP access point. Network nodes 1410 facilitate direct or indirect connection of UEs, such as by connecting UEs 1412a-d (one or more of which may be generally referred to as UEs 1412) to core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1400 may include any number of wired or wireless networks, network nodes, UEs, and/or any other components or systems that may facilitate or participate in the communication of data and/or signals whether via wired or wireless connections. Communication system 1400 may include and/or interface with any type of communication, telecommunication, data, cellular, radio network, and/or other similar type of system.

UEs 1412 may be any of a wide variety of communication devices, including wireless devices arranged, configured, and/or operable to communicate wirelessly with network nodes 1410 and other communication devices. Similarly, network nodes 1410 are arranged, capable, configured, and/or operable to communicate directly or indirectly with UEs 1412 and/or with other network nodes or equipment in telecommunication network 1402 to enable and/or provide network access, such as wireless network access, and/or to perform other functions, such as administration in telecommunication network 1402.

In the depicted example, core network 1406 connects network nodes 1410 to one or more hosts, such as host 1416. These connections may be direct or indirect via one or more intermediary networks or devices. In other examples, network nodes may be directly coupled to hosts. Core network 1406 includes one or more core network nodes (e.g., 1408) that are structured with hardware and software components. Features of these components may be substantially similar to those described with respect to the UEs, network nodes, and/or hosts, such that the descriptions thereof are generally applicable to the corresponding components of core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1416 may be under the ownership or control of a service provider other than an operator or provider of access network 1404 and/or telecommunication network 1402, and may be operated by the service provider or on behalf of the service provider. Host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1402 is a cellular network that implements 3GPP standardized features. Accordingly, telecommunication network 1402 may support network slicing to provide different logical networks to different devices that are connected to telecommunication network 1402. For example, telecommunication network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1412 are configured to transmit and/or receive information without direct human interaction. For instance, a UE may be designed to transmit information to access network 1404 on a predetermined schedule, when triggered by an internal or external event, or in response to requests from access network 1404. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1414 communicates with access network 1404 to facilitate indirect communication between one or more UEs (e.g., UE 1412c and/or 1412d) and network nodes (e.g., network node 1410b). In some examples, hub 1414 may be a controller, router, content source and analytics, or any of the other communication devices described herein regarding UEs. For example, hub 1414 may be a broadband router enabling access to core network 1406 for the UEs. As another example, hub 1414 may be a controller that sends commands or instructions to one or more actuators in the UEs. Commands or instructions may be received from the UEs, network nodes 1410, or by executable code, script, process, or other instructions in hub 1414. As another example, hub 1414 may be a data collector that acts as temporary storage for UE data and, in some embodiments, may perform analysis or other processing of the data. As another example, hub 1414 may be a content source. For example, for a UE that is a VR headset, display, loudspeaker or other media delivery device, hub 1414 may retrieve VR assets, video, audio, or other media or data related to sensory information via a network node, which hub 1414 then provides to the UE either directly, after performing local processing, and/or after adding additional local content. In still another example, hub 1414 acts as a proxy server or orchestrator for the UEs, in particular in if one or more of the UEs are low energy IoT devices.

Hub 1414 may have a constant/persistent or intermittent connection to network node 1410b. Hub 1414 may also allow for a different communication scheme and/or schedule between hub 1414 and UEs (e.g., UE 1412c and/or 1412d), and between hub 1414 and core network 1406. In other examples, hub 1414 is connected to core network 1406 and/or one or more UEs via a wired connection. Moreover, hub 1414 may be configured to connect to an M2M service provider over access network 1404 and/or to another UE over a direct connection. In some scenarios, UEs may establish a wireless connection with network nodes 1410 while still connected via hub 1414 via a wired or wireless connection. In some embodiments, hub 1414 may be a dedicated hub—that is, a hub whose primary function is to route communications to/from the UEs from/to network node 1410b. In other embodiments, hub 1414 may be a non-dedicated hub—that is, a device which is capable of operating to route communications between the UEs and network node 1410b, but which is additionally capable of operating as a communication start and/or end point for certain data channels.

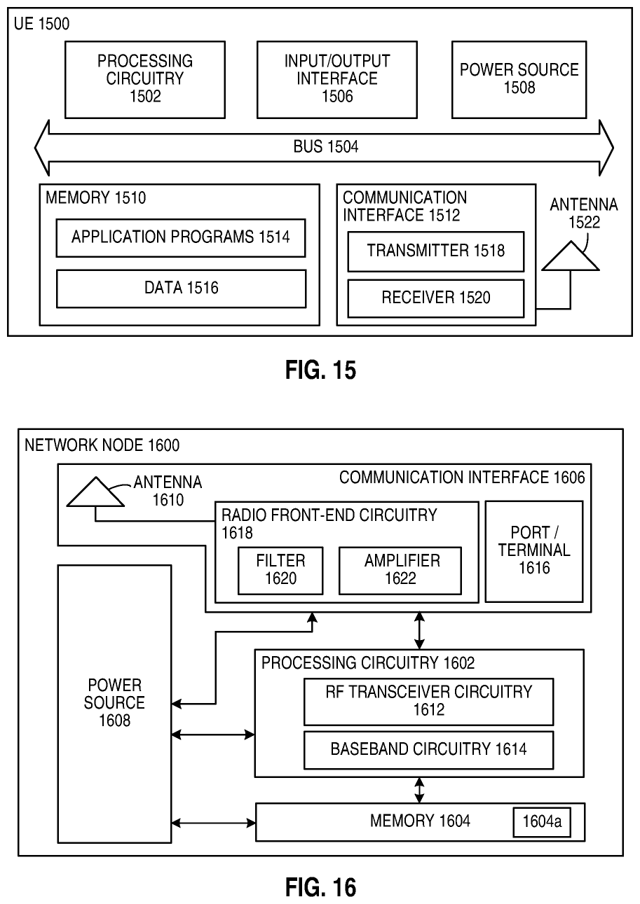

FIG. 15 shows a UE 1500 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1500 includes processing circuitry 1502 that is operatively coupled via bus 1504 to input/output interface 1506, power source 1508, memory 1510, communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

Processing circuitry 1502 is configured to process instructions and data and may be configured to implement any sequential state machine operative to execute instructions stored as machine-readable computer programs in memory 1510. Processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1502 may include multiple central processing units (CPUs).

In the example, input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc. or any combination thereof. An output device may use the same type of interface port as an input device. For example, a Universal Serial Bus (USB) port may be used to provide an input device and an output device.

In some embodiments, power source 1508 is structured as a battery or battery pack. Other types of power sources, such as an external power source (e.g., an electricity outlet), photovoltaic device, or power cell, may be used. Power source 1508 may further include power circuitry for delivering power from power source 1508 itself, and/or an external power source, to the various parts of UE 1500 via input circuitry or an interface such as an electrical power cable. Delivering power may be, for example, for charging power source 1508. Power circuitry may perform any formatting, converting, or other modification to the power from power source 1508 to make the power suitable for the respective components of UE 1500 to which power is supplied.

Memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1510 includes one or more application programs 1514, such as an operating system, web browser application, a widget, gadget engine, or other application, and corresponding data 1516. Memory 1510 may store, for use by UE 1500, any of a variety of various operating systems or combinations of operating systems.

Memory 1510 may be configured to include a number of physical drive units, such as redundant array of independent disks (RAID), flash memory. USB flash drive, external hard disk drive, thumb drive, pen drive, key drive, high-density digital versatile disc (HD-DVD) optical disc drive, internal hard disk drive. Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1510 may allow UE 1500 to access instructions, application programs and the like, stored on transitory or non-transitory memory media, to off-load data, or to upload data. An article of manufacture, such as one utilizing a communication system may be tangibly embodied as or in memory 1510, which may be or comprise a device-readable storage medium.

Processing circuitry 1502 may be configured to communicate with an access network or other network using communication interface 1512. Communication interface 1512 may comprise one or more communication subsystems and may include or be communicatively coupled to an antenna 1522. Communication interface 1512 may include one or more transceivers used to communicate, such as by communicating with one or more remote transceivers of another device capable of wireless communication (e.g., another UE or a network node in an access network). Each transceiver may include transmitter 1518 and/or receiver 1520 appropriate to provide network communications (e.g., optical, electrical, frequency allocations, and so forth). Moreover, transmitter 1518 and receiver 1520 may be coupled to one or more antennas (e.g., 1522) and may share circuit components, software or firmware, or alternatively be implemented separately.

In the illustrated embodiment, communication functions of communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1600 includes processing circuitry 1602, memory 1604, communication interface 1606, and power source 1608. Network node 1600 may be composed of multiple physically separate components (e.g., a NodeB component and a RNC component, or a BTS component and a BSC component, etc.), which may each have their own respective components. In certain scenarios in which network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). Network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

Processing circuitry 1602 may comprise a combination of one or more of a microprocessor, controller, microcontroller, central processing unit, digital signal processor. application-specific integrated circuit, field programmable gate array, or any other suitable computing device, resource, or combination of hardware, software and/or encoded logic operable to provide, either alone or in conjunction with other network node 1600 components, such as memory 1604, to provide network node 1600 functionality.

In some embodiments, processing circuitry 1602 includes a system on a chip (SOC). In some embodiments, processing circuitry 1602 includes one or more of radio frequency (RF) transceiver circuitry 1612 and baseband processing circuitry 1614. In some embodiments. RF transceiver circuitry 1612 and baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

Memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1602. Memory 1604 may store any suitable instructions, data, or information, including a computer program, software, an application including one or more of logic, rules, code, tables, and/or other instructions (collectively denoted computer program 1604a, which may be in the form of a computer program product) capable of being executed by processing circuitry 1602 and utilized by network node 1600. Memory 1604 may be used to store any calculations made by processing circuitry 1602 and/or any data received via communication interface 1606. In some embodiments, processing circuitry 1602 and memory 1604 is integrated.

Communication interface 1606 is used in wired or wireless communication of signaling and/or data between a network node, access network, and/or UE. As illustrated, communication interface 1606 comprises port(s)/terminal(s) 1616 to send and receive data, for example to and from a network over a wired connection. Communication interface 1606 also includes radio front-end circuitry 1618 that may be coupled to, or in certain embodiments a part of, antenna 1610. Radio front-end circuitry 1618 comprises filters 1620 and amplifiers 1622. Radio front-end circuitry 1618 may be connected to antenna 1610 and processing circuitry 1602. The radio front-end circuitry may be configured to condition signals communicated between antenna 1610 and processing circuitry 1602. Radio front-end circuitry 1618 may receive digital data that is to be sent out to other network nodes or UEs via a wireless connection. Radio front-end circuitry 1618 may convert the digital data into a radio signal having the appropriate channel and bandwidth parameters using a combination of filters 1620 and/or amplifiers 1622. The radio signal may then be transmitted via antenna 1610. Similarly, when receiving data, antenna 1610 may collect radio signals which are then converted into digital data by radio front-end circuitry 1618. The digital data may be passed to processing circuitry 1602. In other embodiments, the communication interface may comprise different components and/or different combinations of components.

In certain alternative embodiments, network node 1600 does not include separate radio front-end circuitry 1618, instead, processing circuitry 1602 includes radio front-end circuitry and is connected to antenna 1610. Similarly, in some embodiments, all or some of RF transceiver circuitry 1612 is part of communication interface 1606. In still other embodiments, communication interface 1606 includes one or more ports or terminals 1616, radio front-end circuitry 1618, and RF transceiver circuitry 1612, as part of a radio unit (not shown), and communication interface 1606 communicates with baseband processing circuitry 1614, which is part of a digital unit (not shown).

Antenna 1610 may include one or more antennas, or antenna arrays, configured to send and/or receive wireless signals. Antenna 1610 may be coupled to radio front-end circuitry 1618 and may be any type of antenna capable of transmitting and receiving data and/or signals wirelessly. In certain embodiments, antenna 1610 is separate from network node 1600 and connectable to network node 1600 through an interface or port.

Antenna 1610, communication interface 1606, and/or processing circuitry 1602 may be configured to perform any receiving operations and/or certain obtaining operations described herein as being performed by the network node. Any information, data and/or signals may be received from a UE, another network node and/or any other network equipment. Similarly, antenna 1610, communication interface 1606, and/or processing circuitry 1602 may be configured to perform any transmitting operations described herein as being performed by the network node. Any information, data and/or signals may be transmitted to a UE, another network node and/or any other network equipment.

Power source 1608 provides power to the various components of network node 1600 in a form suitable for the respective components (e.g., at a voltage and current level needed for each respective component). Power source 1608 may further comprise, or be coupled to, power management circuitry to supply the components of network node 1600 with power for performing the functionality described herein. For example, network node 1600 may be connectable to an external power source (e.g., the power grid, an electricity outlet) via an input circuitry or interface such as an electrical cable, whereby the external power source supplies power to power circuitry of power source 1608. As a further example, power source 1608 may comprise a source of power in the form of a battery or battery pack which is connected to, or integrated in, power circuitry. The battery may provide backup power should the external power source fail.

Embodiments of network node 1600 may include additional components beyond those shown in FIG. 16 for providing certain aspects of the network node's functionality, including any of the functionality described herein and/or any functionality necessary to support the subject matter described herein. For example, network node 1600 may include user interface equipment to allow input of information into network node 1600 and to allow output of information from network node 1600. This may allow a user to perform diagnostic, maintenance, repair, and other administrative functions for network node 1600.

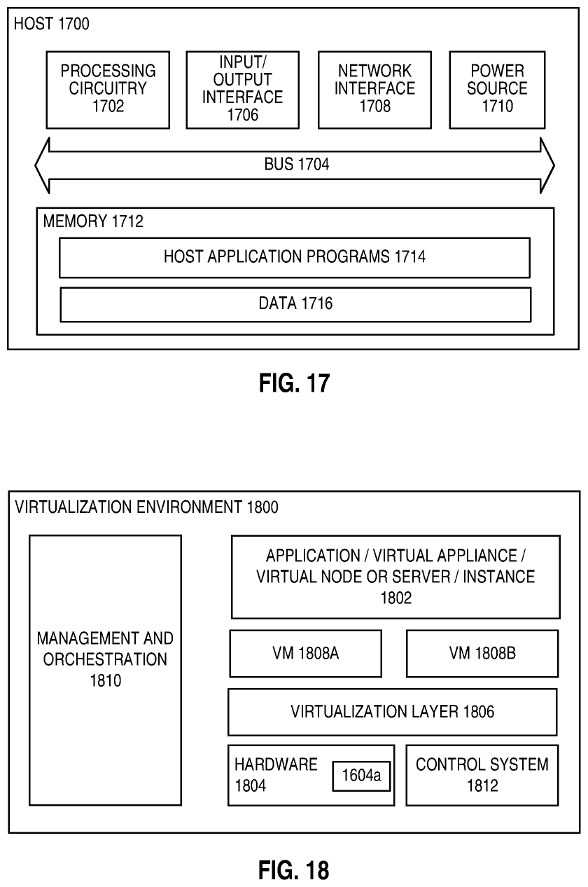

FIG. 17 is a block diagram of a host 1700, which may be an embodiment of host 1416 of FIG. 14, in accordance with various aspects described herein. As used herein, host 1700 may be or comprise various combinations hardware and/or software, including standalone server, blade server, cloud-implemented server, distributed server, virtual machine, container, or processing resources in a server farm. Host 1700 may provide one or more services to one or more UEs.

Host 1700 includes processing circuitry 1702 that is operatively coupled via bus 1704 to input/output interface 1706, network interface 1708, power source 1710, and memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

Memory 1712 may include one or more computer programs including one or more host application programs 1714 and data 1716, which may include user data, e.g., data generated by a UE for host 1700 or data generated by host 1700 for a UE. Embodiments of host 1700 may utilize only a subset or all of the components shown. Host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1714 may also provide for user authentication and licensing checks and may periodically report health, routes, and content availability to a central node, such as a device in or on the edge of a core network. Accordingly, host 1700 may select and/or indicate a different host for over-the-top services for a UE. Host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in virtualization environment 1800 to implement some of the features, functions, and/or benefits of some of the embodiments disclosed herein.

Hardware 1804 includes processing circuitry, memory that stores software and/or instructions (collectively denoted computer program 1804a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a-b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

VMs 1808 comprise virtual processing, virtual memory, virtual networking or interface and virtual storage, and may be run by a corresponding virtualization layer 1806. Different embodiments of a virtual appliance 1802 may be implemented on one or more VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be in data centers, and customer premise equipment.

In the context of NFV, each VM 1808 may be a software implementation of a physical machine that runs programs as if they were executing on a physical, non-virtualized machine. Each VM 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of hardware 1804 and corresponds to application 1802.

Hardware 1804 may be implemented in a standalone network node with generic or specific components. Hardware 1804 may implement some functions via virtualization. Alternatively, hardware 1804 may be part of a larger cluster of hardware (e.g., such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

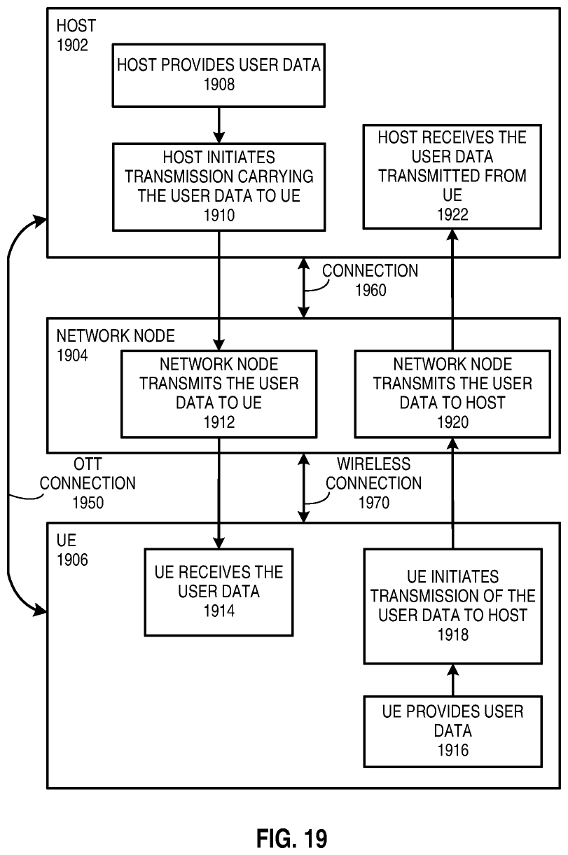

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. Host 1902 also includes software, which is stored in or accessible by host 1902 and executable by the processing circuitry. The software includes a host application that may be operable to provide a service to a remote user, such as UE 1906 connecting via an over-the-top (OTT) connection 1950 extending between UE 1906 and host 1902. In providing the service to the remote user, a host application may provide user data which is transmitted using OTT connection 1950.

Network node 1904 includes hardware enabling it to communicate with host 1902 and UE 1906. Connection 1960 may be direct or pass through a core network (like core network 1406 of FIG. 14) and/or one or more other intermediate networks, such as one or more public, private, or hosted networks. For example, an intermediate network may be a backbone network or the Internet.

UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of host 1902. In host 1902, an executing host application may communicate with the executing client application via OTT connection 1950 terminating at UE 1906 and host 1902. In providing the service to the user, the UE's client application may receive request data from the host's host application and provide user data in response to the request data. OTT connection 1950 may transfer both the request data and the user data. The UE's client application may interact with the user to generate the user data that it provides to the host application through OTT connection 1950.

OTT connection 1950 may extend via a connection 1960 between host 1902 and network node 1904 and via a wireless connection 1970 between network node 1904 and UE 1906 to provide the connection between host 1902 and UE 1906. Connection 1960 and wireless connection 1970, over which OTT connection 1950 may be provided, have been drawn abstractly to illustrate the communication between host 1902 and UE 1906 via network node 1904, without explicit reference to any intermediary devices and the precise routing of messages via these devices.

As an example of transmitting data via OTT connection 1950, in step 1908, host 1902 provides user data, which may be performed by executing a host application. In some embodiments, the user data is associated with a particular human user interacting with UE 1906. In other embodiments, the user data is associated with a UE 1906 that shares data with host 1902 without explicit human interaction. In step 1910, host 1902 initiates a transmission carrying the user data towards UE 1906. Host 1902 may initiate the transmission responsive to a request transmitted by UE 1906. The request may be caused by human interaction with UE 1906 or by operation of the client application executing on UE 1906. The transmission may pass via network node 1904, in accordance with the teachings of the embodiments described throughout this disclosure. Accordingly, in step 1912, network node 1904 transmits to UE 1906 the user data that was carried in the transmission that host 1902 initiated, in accordance with the teachings of the embodiments described throughout this disclosure. In step 1914, UE 1906 receives the user data carried in the transmission, which may be performed by a client application executed on UE 1906 associated with the host application executed by host 1902.

In some examples, UE 1906 executes a client application which provides user data to host 1902. The user data may be provided in reaction or response to the data received from host 1902. Accordingly, in step 1916, UE 1906 may provide user data, which may be performed by executing the client application. In providing the user data, the client application may further consider user input received from the user via an input/output interface of UE 1906. Regardless of the specific manner in which the user data was provided, UE 1906 initiates, in step 1918, transmission of the user data towards host 1902 via network node 1904. In step 1920, in accordance with the teachings of the embodiments described throughout this disclosure, network node 1904 receives user data from UE 1906 and initiates transmission of the received user data towards host 1902. In step 1922, host 1902 receives the user data carried in the transmission initiated by UE 1906.

One or more of the various embodiments improve the performance of OTT services provided to UE 1906 using OTT connection 1950, in which wireless connection 1970 forms the last segment. More precisely, embodiments described herein can facilitate execution of L1/L2 inter-cell mobility much faster than the existing L3-based inter-cell mobility since the execution phase is separated from the preparation phase, so that timing of the lower layer signaling triggering execution of L1/L2 inter-cell mobility is up to the discretion of the source DU. These advantages are enabled by providing the UE with a TCI state ID or an SSB index for the candidate cell in the lower layer signaling that triggers execution of L1/L2 inter-cell mobility. which facilitates timely UE communication with the candidate cell. Furthermore, by providing a UE with an indication of whether the UE should perform a MAC reset in conjunction with the L1/L2 inter-cell mobility, embodiments avoid data losses and excess interruptions when MAC resets are unnecessary. At a high level, embodiments improve mobility in RANs (e.g., NG-RANs). By improving operation of UEs and RANs in this manner, embodiments increase the value of OTT services delivered to/from the UE via the RAN.

In an example scenario, factory status information may be collected and analyzed by host 1902. As another example, host 1902 may process audio and video data which may have been retrieved from a UE for use in creating maps. As another example, host 1902 may collect and analyze real-time data to assist in controlling vehicle congestion (e.g., controlling traffic lights). As another example, host 1902 may store surveillance video uploaded by a UE. As another example, host 1902 may store or control access to media content such as video, audio, VR or AR which it can broadcast, multicast or unicast to UEs. As other examples, host 1902 may be used for energy pricing, remote control of non-time critical electrical load to balance power generation needs, location services, presentation services (such as compiling diagrams etc, from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1950 between host 1902 and UE 1906, in response to variations in the measurement results. The measurement procedure and/or the network functionality for reconfiguring the OTT connection may be implemented in software and hardware of host 1902 and/or UE 1906. In some embodiments, sensors (not shown) may be deployed in or in association with other devices through which OTT connection 1950 passes; the sensors may participate in the measurement procedure by supplying values of the monitored quantities exemplified above, or supplying values of other physical quantities from which software may compute or estimate the monitored quantities. Reconfiguring OTT connection 1950 may include message format, retransmission settings, preferred routing etc.; the reconfiguration need not directly alter the operation of network node 1904. Such procedures and functionalities may be known and practiced in the art. In certain embodiments, measurements may involve proprietary UE signaling that facilitates measurements of throughput, propagation times, latency and the like, by host 1902. The measurements may be implemented in that software causes messages to be transmitted, in particular empty or “dummy” messages, using OTT connection 1950 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset: this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of a network node and a wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:
A1. A method for a user equipment (UE) configured to communicate with a radio access network (RAN) node comprising a central unit (CU) and a distributed unit (DU) that provides a serving cell for the UE, the method comprising:
   receiving, from the DU, a lower layer signalling message indicating that the UE should perform L1/L2-based inter-cell mobility to a first candidate cell provided by a candidate DU, wherein the lower layer signaling message includes:
      an indicator or identity of the first candidate cell, and
      an indication of a first transmission configuration indicator (TCI) state to be used by the UE for communicating with the first candidate cell;
   performing an L1/L2 mobility procedure towards the first candidate cell and communicating in the first candidate cell based on the first TCI state.
A2. The method of embodiment A1, wherein the indication of the first TCI state is a TCI state identifier.
A3. The method of embodiment A1, wherein the indication of the first TCI state is an index of a first beam or reference signal (RS) transmitted in the first candidate cell.
A4. The method of embodiment A3, further comprising:
   receiving, from the CU via the DU, an RRCReconfiguration message that includes configurations associated with one or more candidate cells for L1/L2-based inter-cell mobility, including the first candidate cell, wherein:
      each candidate cell configuration includes a plurality of TCI state configurations, and
      each TCI state configuration includes an index of a beam or RS arranged as a quasi-co-location (QCL) source; and
   selecting, as the first TCI state, one of the TCI state configurations that includes the index of the first beam or RS as a QCL source.
A5. The method of embodiment A4, further comprising sending, to the CU via the DU, an RRCReconfigurationComplete message responsive to the RRCReconfiguration message.
A5a. The method of any of embodiments A4-A5, wherein the configuration for the first candidate cell includes an indication of whether the UE should perform a medium access control (MAC) reset when executing the L1/L2 inter-cell mobility to the first candidate cell.
A6. The method of any of embodiments A1-A5a, wherein the method further comprises:
   performing measurements on a plurality of beams or reference signals (RS) transmitted in the first candidate cell: and
   sending results of the measurements to the DU,
   wherein the first TCI state corresponds to an index of a beam or RS with measurement results most favorable for L1/L2 mobility to the first candidate cell.
A6a. The method of embodiment A6, wherein the plurality of beams or RS include one or more of the following: synchronization signal/PBCH blocks (SSBs), and channel state information reference signals (CSI-RS).
A7. The method of any of embodiments A1-A6, wherein the lower layer signaling message also includes one or more of the following:
   an indication of whether the UE should perform a random access (RA) procedure when executing L1/L2 inter-cell mobility to the first candidate cell; and
   an indication of whether the UE should perform a medium access control (MAC) reset when executing the L1/L2 inter-cell mobility to the first candidate cell.
A8. The method of embodiment A7, wherein performing the L1/L2 mobility procedure towards the first candidate cell comprises selectively performing one or more of the following operations based on the indication of whether the UE should perform a MAC reset:
   initializing a MAC state variable;
   stopping, starting, or restarting a MAC timer;
   resetting new data indictors (NDIs) for uplink hybrid ARQ processes to zero;
   stopping an ongoing MAC procedure;
   canceling a MAC procedure that has been triggered but is not ongoing;
   flushing a MAC message buffer;
   resetting a MAC counter; and
   releasing a radio network temporary identifier (RNTI) assigned to the UE.
A9. The method of any of embodiments A7-A8, wherein performing the L1/L2 mobility procedure towards the first candidate cell comprises selectively performing a RA procedure in the first candidate cell based on one or more of the following:
   the indication of whether the UE should perform a RA procedure;
   whether time alignment of the first candidate cell is different from time alignment of the serving cell;
   whether a time alignment timer of the first candidate cell has expired; and
   whether time alignment of the first candidate cell is known or unknown.
A10. The method of any of embodiments A1-A9, wherein one or more of the following applies:
   the lower layer signaling message is for a protocol layer below the radio resource control (RRC) protocol layer; and
   the lower layer signaling message is one of the following: MAC Control Element (MAC CE), or PHY Downlink Control Information (DCI).
A11. The method of any of embodiments A1-A10, wherein communicating in the first candidate cell based on the first TCI state includes one or more of the following:
   monitoring a downlink control channel of the first candidate cell in a beam or spatial direction corresponding to the first TCI state; and
   transmitting uplink data or a scheduling request to the first candidate cell in a beam or spatial direction corresponding to the first TCI state.
A12. The method of any of embodiments A1-A11, wherein the candidate DU is associated with the CU and/or is part of the RAN node.
B1. A method for a distributed unit (DU) of a radio access network (RAN) node, the DU being coupled to a central unit (CU) of the RAN node and configured to provide a serving cell for user equipment (UEs), the method comprising:
   selecting a first candidate cell, provided by a candidate DU, for L1/L2-based inter-cell mobility of a UE currently being served by DU via the serving cell; and
   sending, to the UE, a lower layer signalling message indicating that the UE should perform L1/L2-based inter-cell mobility to the first candidate cell, wherein the lower layer signaling message includes:
      an indicator or identity of the first candidate cell, and
      an indication of a first transmission configuration indicator (TCI) state to be used by the UE for communicating with the first candidate cell.
B2. The method of embodiment A1-A5a, further comprising receiving, from the UE, results of measurements performed by the UE on a plurality of beams or reference signals (RS) transmitted in the first candidate cell, wherein the measurement results include respective indices of the plurality of beams or RS.
B2a. The method of embodiment B2, wherein the plurality of beams or RS include one or more of the following: synchronization signal/PBCH blocks (SSBs), and channel state information reference signals (CSI-RS).
B3. The method of any of embodiments B2-B2a, wherein the first TCI state is associated with a first beam or RS having measurement results that are most favorable for L1/L2 mobility to the first candidate cell.
B4. The method of embodiment B3, wherein the indication of the first TCI state is the index of the first beam or RS.
B5. The method of embodiment B3, wherein the indication of the first TCI state is a TCI state identifier.
B6. The method of embodiment B5, further comprising determining the TCI state identifier for the first TCI state based on the index of the first beam or RS and a mapping between TCI state identifiers used in the first candidate cell and indices of beams or RS transmitted in the first candidate cell.
B7. The method of embodiment B6, further comprising receiving the mapping from one of the following: the candidate DU, or the CU.
B8. The method of any of embodiments B1-B7, further comprising sending, to the CU or to the candidate DU, a message including one or more of the following:
   the indicator or identity of the first candidate cell for the UE's L1/L2-based inter-cell mobility;
   the indication of the first TCI state to be used by the UE for communicating with the first candidate cell; and
   a copy or encapsulation of the lower layer signaling message.
B9. The method of any of embodiments B1-B8, wherein the lower layer signaling message also includes one or more of the following:
   an indication of whether the UE should perform a random access (RA) procedure when executing L1/L2 inter-cell mobility to the first candidate cell; and
   an indication of whether the UE should perform a medium access control (MAC) reset when executing the L1/L2 inter-cell mobility to the first candidate cell.
B10. The method of embodiment B9, further comprising determining whether the UE should perform a RA procedure when executing L1/L2 inter-cell mobility to the first candidate cell, as indicated in the lower layer signaling message, based on one or more of the following:
   whether time alignment of the first candidate cell is different from time alignment of the serving cell:
   whether a time alignment timer of the first candidate cell has expired; and
   whether time alignment of the first candidate cell is known or unknown.
B11. The method of any of embodiments B1-B10, wherein one or more of the following applies:
   the lower layer signaling message is for a protocol layer below the radio resource control (RRC) protocol layer; and
   the lower layer signaling message is one of the following: MAC Control Element (MAC CE), or PHY Downlink Control Information (DCI).
B12. The method of any of embodiments B1-B11, wherein the candidate DU is associated with the CU and/or is part of the RAN node.
B13. The method of any of embodiments B1-B12, further comprising:
   sending, to the CU or to the candidate DU, a request to configure the UE with at least one candidate cell for L1/L2-based inter-cell mobility;
   receiving, from the CU or the candidate DU, a configuration for one or more candidate cells provided by the candidate DU, including the first candidate cell; and
   sending the configuration to the UE in an RRCReconfiguration message.
C1. A method for a candidate distributed unit (DU) of a radio access network (RAN) node, the candidate DU being coupled to a central unit (CU) of the RAN node, the method comprising:
   receiving, from the CU or from a DU currently serving a UE via a serving cell, a request to configure the UE with at least one candidate cell for L1/L2-based inter-cell mobility;
   sending, to the CU or the DU, a configuration for one or more candidate cells provided by the candidate DU, including the first candidate cell;
   receiving, from the DU, a message indicating an L1/L2 mobility procedure by the UE, wherein the message includes:
      an indicator or identity of the first candidate cell for the UE's L1/L2-based inter-cell mobility; and
      an indication of a first transmission configuration indicator (TCI) state to be used by the UE for communicating with the first candidate cell; and
   communicating with the UE in the first candidate cell based on the first TCI state.
C2. The method of embodiment C1, wherein the indicator or identity of the first candidate cell and the indication of the first TCI state are received in a copy or encapsulation of a lower layer signaling message sent by the DU to the UE.
C3. The method of any of embodiments C1-C2, wherein the indication of the first TCI state is an index of a first beam or reference signal (RS) transmitted in the candidate cell.
C4. The method of embodiment C3, further comprising determining the first TCI state, or an identifier thereof, based on the index of the first beam or RS and a mapping between TCI state identifiers used in the first candidate cell and indices of beams or RS transmitted in the first candidate cell.
C5. The method of any of embodiments C1-C2, wherein:
   the indication of the first TCI state is a TCI state identifier; and
   the method further comprises sending, to the CU or to the DU, a mapping between TCI state identifiers used in the first candidate cell and indices of beams or RS transmitted in the first candidate cell.
C6. The method of any of embodiments C1-C5, wherein the configuration for the first candidate cell includes an indication of whether the UE should perform a medium access control (MAC) reset when executing the L1/L2 inter-cell mobility to the first candidate cell.
C7. The method of any of embodiments C1-C6, wherein communicating with the UE in the first candidate cell based on the first TCI state includes one or more of the following:
   transmitting a control channel of the first candidate cell in a beam or spatial direction corresponding to the first TCI; and
   receiving uplink data or a scheduling request from the UE in the first candidate cell, in a beam or spatial direction corresponding to the first TCI state.
C8. The method of any of embodiments C1-C7, wherein the DU is associated with the CU and/or is part of the RAN node.
D1. A user equipment (UE) configured to communicate with a radio access network (RAN) node comprising a central unit (CU) and a distributed unit (DU) that provides a serving cell for the UE, the UE comprising:
communication interface circuitry configured to communicate with the CU and at least the DU; and
processing circuitry operably coupled to the communication interface circuitry, wherein the processing circuitry and communication interface circuitry are further configured to perform operations corresponding to any of the methods of embodiments A1-A12.
D2. A user equipment (UE) configured to communicate with a radio access network (RAN) node comprising a central unit (CU) and a distributed unit (DU) that provides a serving cell for the UE, the UE being further configured to perform operations corresponding to any of the methods of embodiments A1-A12.
D3. A non-transitory, computer-readable medium storing computer-executable instructions that, when executed by processing circuitry of a user equipment (UE) configured to communicate with a radio access network (RAN) node comprising a central unit (CU) and a distributed unit (DU) that provides a serving cell for the UE, configure the UE to perform operations corresponding to any of the methods of embodiments A1-A12.
D4. A computer program product comprising computer-executable instructions that, when executed by processing circuitry of a user equipment (UE) configured to communicate with a radio access network (RAN) node comprising a central unit (CU) and a distributed unit (DU) that provides a serving cell for the UE, configure the UE to perform operations corresponding to any of the methods of embodiments A1-A12.
E1. A distributed unit (DU) of a radio access network (RAN) node, the DU being coupled to a central unit (CU) of the RAN node and configured to provide a serving cell for user equipment (UEs), the DU comprising:
   communication interface circuitry configured to communicate with the CU and with the UEs; and
   processing circuitry operably coupled to the communication interface circuitry, whereby the processing circuitry and the communication interface circuitry are configured to perform operations corresponding to any of the methods of embodiments B1-B13.
E2. A distributed unit (DU) of a radio access network (RAN) node, the DU being coupled to a central unit (CU) of the RAN node and configured to provide a serving cell for user equipment (UEs), the DU being further configured to perform operations corresponding to any of the methods of embodiments B1-B13.
E3. A non-transitory, computer-readable medium storing computer-executable instructions that, when executed by processing circuitry of a distributed unit (DU) coupled to a central unit (CU) of a radio access network (RAN) node and configured to provide a serving cell for user equipment (UEs), configure the DU to perform operations corresponding to any of the methods of embodiments B1-B13.
E4. A computer program product comprising computer-executable instructions that, when executed by processing circuitry of a distributed unit (DU) coupled to a central unit (CU) of a radio access network (RAN) node and configured to provide a serving cell for user equipment (UEs), configure the DU to perform operations corresponding to any of the methods of embodiments B1-B13.
F1. A candidate distributed unit (DU) of a radio access network (RAN) node, the candidate DU being coupled to a central unit (CU) of the RAN node, the candidate DU comprising:
communication interface circuitry configured to communicate with the CU and with UEs via one or more cells provided by the candidate DU; and
processing circuitry operably coupled to the communication interface circuitry, whereby the processing circuitry and communication interface circuitry are configured to perform operations corresponding to any of the methods of embodiments C1-C8.
F2. A second distributed unit (DU), of a radio access network (RAN) node, that is coupled to a centralized unit (CU) of the RAN node, the second DU being configured to perform operations corresponding to any of the methods of embodiments C1-C8.
F3. A non-transitory, computer-readable medium storing computer-executable instructions that, when executed by processing circuitry of a candidate distributed unit (DU) coupled to a central unit (CU) of a radio access network (RAN) node, configure the candidate DU to perform operations corresponding to any of the methods of embodiments C1-C8.
F4. A computer program product comprising computer-executable instructions that, when executed by processing circuitry of a candidate distributed unit (DU) coupled to a central unit (CU) of a radio access network (RAN) node, configure the candidate DU to perform operations corresponding to any of the methods of embodiments C1-C8.

1.-51. (canceled)

52. A method for a user equipment (UE) configured to communicate with a radio access network (RAN) node comprising a central unit (CU) and a distributed unit (DU) that provides a serving cell for the UE, the method comprising:
receiving, from the DU, a lower layer signalling message indicating that the UE should perform layer-1/layer-2 (L1/L2) inter-cell mobility to a first candidate cell provided by a candidate DU, wherein the lower layer signaling message includes the following:
an indicator or identity of the first candidate cell, and
an indication of a first transmission configuration indicator (TCI) state to be used by the UE for communicating with the first candidate cell;
performing an L1/L2 mobility procedure towards the first candidate cell and communicating in the first candidate cell based on the first TCI state.

53. The method of claim 52, wherein the indication of the first TCI state is one of the following: a TCI state identifier, or an index of a first beam or reference signal (RS) transmitted in the first candidate cell.

54. The method of claim 53, further comprising:
receiving, from the CU via the DU, an RRCReconfiguration message that includes configurations associated with one or more candidate cells for L1/L2 inter-cell mobility, including the first candidate cell, wherein:
each candidate cell configuration includes a plurality of TCI state configurations, and
each TCI state configuration includes an index of a beam or RS arranged as a quasi-co-location (QCL) source; and
selecting, as the first TCI state, one of the TCI state configurations that includes the index of the first beam or RS as a QCL source.

55. The method of claim 54, further comprising sending, to the CU via the DU, an RRCReconfigurationComplete message responsive to the RRCReconfiguration message.

56. The method of claim 54, wherein one of the following includes an indication of whether the UE should perform a medium access control (MAC) reset when executing the L1/L2 inter-cell mobility to the first candidate cell: the configuration for the first candidate cell, or the lower layer signaling message.

57. The method of claim 56, wherein performing the L1/L2 mobility procedure towards the first candidate cell comprises selectively performing one or more of the following operations based on the indication of whether the UE should perform a MAC reset:
initializing a MAC state variable;
stopping, starting, or restarting a MAC timer;
resetting new data indicators (NDIs) for uplink hybrid ARQ processes to zero;
stopping an ongoing MAC procedure;
cancelling a MAC procedure that has been triggered but is not ongoing;
flushing a MAC message buffer;
resetting a MAC counter; and
releasing a radio network temporary identifier (RNTI) assigned to the UE.

58. The method of claim 52, wherein the lower layer signaling message also includes an indication of whether the UE should perform a random access (RA) procedure when executing L1/L2 inter-cell mobility to the first candidate cell.

59. The method of claim 58, wherein performing the L1/L2 mobility procedure towards the first candidate cell comprises selectively performing a RA procedure in the first candidate cell based on one or more of the following:
the indication of whether the UE should perform a RA procedure;
whether time alignment of the first candidate cell is different from time alignment of the serving cell;
whether a time alignment timer of the first candidate cell has expired; and
whether time alignment of the first candidate cell is known or unknown.

60. The method of claim 52, wherein the method further comprises:
performing measurements on a plurality of beams or reference signals (RS) transmitted in the first candidate cell; and
sending results of the measurements to the DU,
wherein the first TCI state corresponds to an index of a beam or RS with measurement results most favorable for L1/L2 mobility to the first candidate cell.

61. The method of claim 60, wherein the plurality of beams or RS include one or more of the following: synchronization signal/PBCH blocks (SSBs), and channel state information reference signals (CSI-RS).

62. The method of claim 52, wherein one or more of the following applies:
the lower layer signaling message is for a protocol layer below the radio resource control (RRC) protocol layer; and
the lower layer signaling message is one of the following: medium access control (MAC) control element (CE), or physical layer downlink control information (DCI).

63. The method of claim 52, wherein communicating in the first candidate cell based on the first TCI state includes one or more of the following:
monitoring a downlink control channel of the first candidate cell in a beam or spatial direction corresponding to the first TCI state; and
transmitting uplink data or a scheduling request to the first candidate cell in a beam or spatial direction corresponding to the first TCI state.

64. The method of claim 52, wherein the candidate DU is associated with the CU and/or is part of the RAN node.

65. A method for a distributed unit (DU) of a radio access network (RAN) node, the DU being configured to communicate with a central unit (CU) of the RAN node and to provide a serving cell for user equipment (UEs) the method comprising:
selecting a first candidate cell, provided by a candidate DU, for layer-1/layer-2 (L1/L2) inter-cell mobility of a UE being served by the DU via the serving cell; and
sending, to the UE, a lower layer signalling message indicating that the UE should perform L1/L2 inter-cell mobility to the first candidate cell, wherein the lower layer signaling message includes the following:
an indicator or identity of the first candidate cell, and
an indication of a first transmission configuration indicator (TCI) state to be used by the UE for communicating with the first candidate cell.

66. The method of claim 65, further comprising receiving, from the UE, results of measurements performed by the UE on a plurality of beams or reference signals (RS) transmitted in the first candidate cell, wherein the measurement results include respective indices of the plurality of beams or RS.

67. The method of claim 66, wherein the plurality of beams or RS include one or more of the following: synchronization signal/PBCH blocks (SSBs), and channel state information reference signals (CSI-RS).

68. The method of claim 66, wherein the first TCI state is associated with a first beam or RS having measurement results that are most favorable for L1/L2 mobility to the first candidate cell.

69. The method of claim 68, wherein the indication of the first TCI state is one of the following: the index of the first beam or RS, or a TCI state identifier.

70. The method of claim 69, further comprising determining the TCI state identifier for the first TCI state based on the following:
the index of the first beam or RS, which is the indication of the first TCI state; and
a mapping between TCI state identifiers used in the first candidate cell and indices of beams or RS transmitted in the first candidate cell.

71. The method of claim 70, further comprising receiving the mapping from the candidate DU or the CU.

72. The method of claim 65, further comprising sending, to the CU or the candidate DU, a message including one or more of the following:
the indicator or identity of the first candidate cell for the UE's L1/L2 inter-cell mobility;
the indication of the first TCI state to be used by the UE for communicating with the first candidate cell; and
a copy or encapsulation of the lower layer signaling message.

73. The method of claim 65, wherein the lower layer signaling message also includes one or more of the following:
an indication of whether the UE should perform a random access (RA) procedure when executing L1/L2 inter-cell mobility to the first candidate cell; and
an indication of whether the UE should perform a medium access control (MAC) reset when executing the L1/L2 inter-cell mobility to the first candidate cell.

74. A user equipment (UE) configured to communicate with a radio access network (RAN) node comprising a central unit (CU) and a distributed unit (DU) that provides a serving cell for the UE, the UE comprising:
communication interface circuitry configured to communicate with the CU and the DU; and
processing circuitry operably coupled to the communication interface circuitry, wherein the processing circuitry and communication interface circuitry are configured to:
receive, from the DU, a lower layer signalling message indicating that the UE should perform layer-1/layer-2 (L1/L2) inter-cell mobility to a first candidate cell provided by a candidate DU, wherein the lower layer signaling message includes the following:
an indicator or identity of the first candidate cell, and
an indication of a first transmission configuration indicator (TCI) state to be used by the UE for communicating with the first candidate cell;
perform an L1/L2 mobility procedure towards the first candidate cell and communicate in the first candidate cell based on the first TCI state.

75. The UE of claim 74, wherein one or more of the following applies:
the indication of the first TCI state is one of the following: a TCI state identifier, or an index of a first beam or reference signal (RS) transmitted in the first candidate cell; and
the lower layer signaling message also includes an indication of whether the UE should perform a random access (RA) procedure when executing L1/L2 inter-cell mobility to the first candidate cell.

76. A distributed unit (DU) of a radio access network (RAN) node, the DU being configured to communicate with a central unit (CU) of the RAN node and to provide a serving cell for user equipment (UEs), the DU comprising:
communication interface circuitry configured to communicate with the UEs via the serving cell and with the CU; and
processing circuitry operably coupled to the communication interface circuitry, wherein the processing circuitry and the communication interface circuitry are configured to:
select a first candidate cell, provided by a candidate DU, for layer-1/layer-2 (L1/L2) inter-cell mobility of a UE being served by the DU via the serving cell; and
send, to the UE, a lower layer signalling message indicating that the UE should perform L1/L2 inter-cell mobility to the first candidate cell, wherein the lower layer signaling message includes the following:
an indicator or identity of the first candidate cell, and
an indication of a first transmission configuration indicator (TCI) state to be used by the UE for communicating with the first candidate cell.

77. The DU of claim 76, wherein:
the processing circuitry and the communication interface circuitry are further configured to receive, from the UE, results of measurements performed by the UE on a plurality of beams or reference signals (RS) transmitted in the first candidate cell; and
the measurement results include respective indices of the plurality of beams or RS.
